(19) United States
(12) Patent Application Publication
(10) Pub. No.: US 2001/0028484 A1
(43) Pub. Date: Oct. 11, 2001

(54) Unitary optical device for use in monitoring the output of a light source

(76) Inventors: Hironori Sasaki, Yamanashi (JP); Takeshi Takamori, Tokyo (JP); Kyoko Kotani, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/813,964

(22) Filed: Mar. 22, 2001

(30) Foreign Application Priority Data
Mar. 31, 2000 (JP) 096006/00
Feb. 16, 2001 (JP) 040160/01

(51) Int. Cl. G03H 1/08

(52) U.S. Cl. 359/19; 359/9; 359/15; 385/37

(57) ABSTRACT

An optical device receives light from an adjustable light source, focuses part of the light into an optical waveguide, and directs another part of the light toward a control unit as monitor light for feedback control of the light source. The optical device is an optical plate with a computer-generated hologram formed on at least one surface to focus light into the optical waveguide. The monitor light may be reflected at this surface or another surface of the optical plate. The monitor light may be focused by the same or another computer-generated hologram.

### BACKGROUND OF THE INVENTION

The present invention relates to an optical device that couples light from a light source into an optical waveguide device and diverts part of the light for use in feedback control of the light source, more particularly to an optical device of this type employing a computer-generated hologram.

Opto-electronic circuits frequently use semiconductor lasers as light sources, and frequently use feedback control to obtain constant optical output from these light sources regardless of ambient temperature and other external factors. In the usual feedback control scheme, part of the light emitted by the semiconductor laser is used to monitor the laser's output level; if the intensity of the monitor light varies, the output level is adjusted to eliminate the variation.

A semiconductor laser has two end facets with mirror surfaces, and normally emits light through both ends. Since the amounts of light emitted at the two ends vary proportionally, a common practice is to use the light emitted from one end as output light, and use the light emitted from the other end as monitor light. The output light is coupled into an optical waveguide device such as an optical fiber; the monitor light is sensed by a photodetector such as a photodiode. To obtain an appropriate amount of monitor light, the mirror surface through which the monitor light is emitted usually has a high reflectivity, approaching one hundred percent.

A problem is that the amount of monitor light obtained depends sensitively on the reflectivity of this highly reflective mirror surface, which in turn is sensitive to variations in the manufacturing process. The intensity of the monitor light therefore tends to vary considerably from one semiconductor laser to another. To compensate for these variations, the feedback control system that receives the monitor light has to be adjusted separately for each semiconductor laser. This is a disadvantage from the standpoints of economy and uniformity of the manufacturing process, particularly in high-volume production.

### SUMMARY OF THE INVENTION

An object of the present invention is to provide an optical device that obtains a uniform amount of monitor light for use in feedback control of a light source.

A further object is to provide an optical device that, while obtaining monitor light, also couples the output light of the light source efficiently into an optical waveguide device.

Another object is to provide an adjustment-free optical device that carries out these monitoring and coupling functions.

The invented optical device comprises an optical plate disposed in the path of light emitted by an adjustable light source, and a computer-generated hologram formed on the optical plate. The computer-generated hologram focuses part of the emitted light into an optical waveguide device. The optical plate directs another part of the emitted light as monitor light to a feedback control system for control of the light source.

The optical waveguide device may be, for example, an optical fiber, or a channel waveguide.

The optical plate is preferably tilted with respect to the beam axis of the light emitted from the light source. This geometry ensures that light reflected from the surface of the optical plate does not reenter the light source. Accordingly, it is not necessary to apply an antireflection coating to the surface of the optical plate.

The computer-generated hologram may be formed by photolithography and etching, using computer-generated mask data. Photolithography and etching technology is well developed because it is employed in the fabrication of semiconductor integrated circuits. This technology can be used to generate a dense hologram with extremely high precision and uniformity.

Although the invented optical device performs two separate functions (focusing light and obtaining monitor light), since it is formed as a single optical plate, it requires no internal adjustments, another reason why it can be manufactured with a high degree of uniformity. In particular, the invented device does not have multiple optical elements requiring axial alignment.

The monitor light may be obtained by reflection from a surface of the optical plate. The computer-generated hologram may be formed on this surface, and may focus the reflected monitor light as well as focusing the transmitted light coupled into the optical waveguide device. For example, diffraction of one order may be used to focus light into the optical waveguide device, and diffraction of another, preferably higher order may be used to focus the monitor light.

Alternatively, the optical plate may have computer-generated holograms formed on both of its surfaces, the computer-generated hologram on one surface focusing transmitted light into the optical waveguide device, the computer-generated hologram on the other surface focusing reflected monitor light. This arrangement enables more intense monitor light to be obtained, and the monitor light can be focused to an arbitrary point independent of the focusing of the transmitted light.

The monitor light may be reflected from a surface of the optical plate without being focused. The reflecting surface may be coated with a semitransparent film to adjust the reflectivity to a desired level. Compared with the highly reflective end facet of a conventional semiconductor laser diode, this reflecting surface has a lower reflectivity, making the intensity of the monitor light less sensitive to manufacturing variations.

### BRIEF DESCRIPTION OF THE DRAWINGS

In the attached drawings:

FIG. 1 shows the general form of the Taylor expansion of an optical path difference function;

FIG. 2 is a sectional view illustrating a first embodiment of the invention;

FIG. 3 is a schematic diagram illustrating the focusing of transmitted light in the first embodiment;

FIGS. 4 to 20 show formulas for phase coefficients used in the first embodiment;

FIGS. 21 and 22 show equations used in determining the minimum line-width dimension of mask patterns used in the first embodiment;

FIG. 23 is a graph showing diffraction efficiency as a function of the ratio of etching depth to wavelength;

FIG. 24 is a sectional view illustrating a second embodiment of the invention;

FIG. 25 is a schematic diagram illustrating the focusing of reflected light in the second embodiment;

FIGS. 26 to 42 show formulas for phase coefficients used in the second embodiment;

FIGS. 43 and 44 show equations used in determining the minimum line-width dimension of mask patterns used in the second embodiment;

FIG. 45 is a sectional view illustrating a third embodiment of the invention; and

FIG. 46 is a sectional view illustrating a variation of the third embodiment.

### DETAILED DESCRIPTION OF THE INVENTION

Embodiments of the invention will be described with reference to the attached drawings, in which like parts are indicated by like reference characters. The description will be preceded by a description of the design and fabrication of a computer-generated hologram. A computer-generated hologram will be referred to below as a CGH.

A CGH is designed by computer-aided techniques based on an optical path difference function. This function relates the phase of light passing through the CGH at an arbitrary point (x, y) to the phase of light passing through the origin (0, 0). The optical path difference function ρ(x, y) is expressed as a polynomial of the following general form.

ρ(x, y)=ΣC_{N}x^{m}yⁿ (1)

The coefficients C_{N}(N=0, 1, 2, . . . are referred to as optical path difference coefficients or phase coefficients. The exponents m and n are non-negative integers related to the subscript N by the following equation, which gives a different value of N for each combination of m and n.

N={(m+n)²+m+3n}/2 (2)

The desired optical path difference function ρ(x, y) is determined from the dimensions of the system in which the CGH will be used. The optical path difference coefficients CN are then calculated as the coefficients of a two-dimensional Taylor-series expansion of the optical path difference function, and the coefficient data are furnished to a computer-aided design (CAD) program. One program that can be used is the CGH CAD program produced by New Interconnection and Packaging Technologies (NIPT) Inc. of San Diego, Calif. To limit the necessary amount of data processing, this program operates only on terms up to the tenth degree (m+n≦10), so N does not exceed sixty-five and it is only necessary to calculate optical path difference coefficients from C₀ to C₆₅. When given these coefficients, the CGH CAD program generates mask-pattern data needed to fabricate a CGH with diffraction characteristics matched to the optical path difference function.

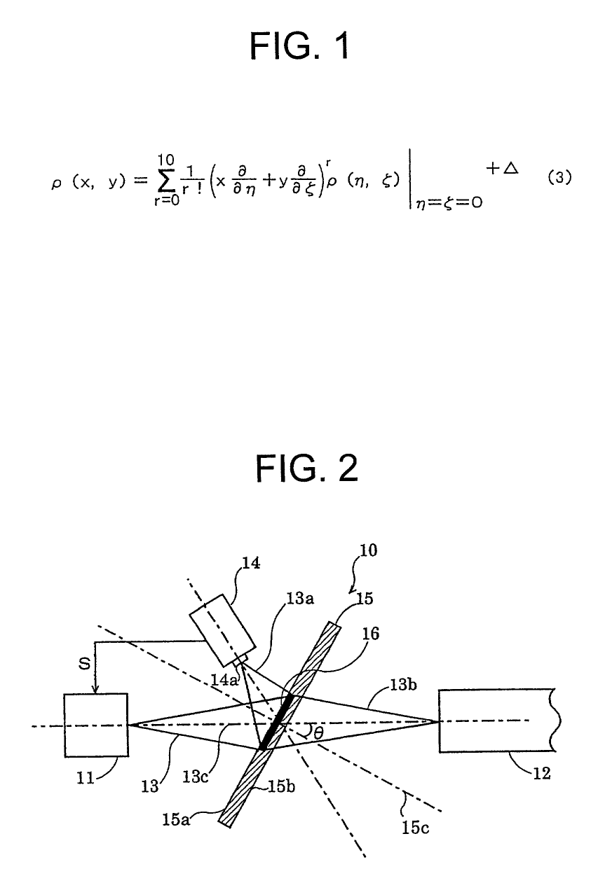

The general form of the Taylor-series expansion is shown as equation (3) in FIG. 1. The Greek letter delta (Δ) on the right side represents a remainder term that is small enough to be ignored.

From the optical path difference coefficients C₀ to C₆₅, the CGH CAD program generates data for a specified number of masks, which are used in combination to fabricate the hologram by photolithography and etching. The multiple masks enable etching to proceed to multiple depths, also referred to as phase levels, so that the hologram approximates the configuration of a type of Fresnel lens.

The number of masks (M) is a parameter that can be selected to obtain a desired number of phase levels N_{X}, where N_{X} is equal to 2^{M}. The larger the number of phase levels, the more closely the CGH can approximate an ideal Fresnel lens. As the number of masks M increases, however, the line-width dimensions of the mask patterns decrease. If M is too large, these dimensions become too small for practical fabrication of the masks, because of tolerances set by photolithographic resolution limits. The number of masks M must be selected so that the minimum line width has a value permitted by the photolithographic resolution.

The hologram can be designed to match the optical path difference function by first-order diffraction, or any other non-zero diffraction order (−1, ±2, ±3, . . . ). First-order diffraction is generally preferred, because it enables the highest diffraction efficiency to be obtained. As will be shown later, the diffraction efficiency depends both on the diffraction order and the ratio of the etching depth to the wavelength of the diffracted light.

FIG. 2 shows a sectional view of a first optical device embodying the present invention. This optical device 10 is disposed between a light source such as a semiconductor laser 11 and an optical waveguide device such as an optical fiber 12. A beam of output light 13 emitted from the semiconductor laser 11 is partly diverted as monitor light 13a to a control unit 14 having a photodetector 14a. The photodetector 14a converts the monitor light 13a to an electrical signal, from which the control unit 14 generates a control signal S that controls the output power level of the semiconductor laser 11. A feedback loop is thus established that holds the amount of output light 13 constant at a predetermined level.

The optical device 10 comprises an optical plate 15 with a pair of parallel flat surfaces 15a, 15b disposed in the path of the output light 13. The optical plate 15 is made of, for example, optical glass with a refractive index of 1.5. Alternatively, the optical plate 15 can be made of a material such as silicon that is highly transparent to light of a specific wavelength, this being the wavelength emitted by the semiconductor laser 11.

The optical plate 15 is inclined so that there is an oblique angle θ between an axis 15c normal to its flat surfaces 15a, 15b and the beam axis 13c of the output light 13. This oblique inclination prevents Fresnel reflection at the front surface 15a from feeding light back into the semiconductor laser 11. Instead, Fresnel reflection at this surface 15a produces the monitor light 13a that is directed toward the control unit 14.

A CGH 16 is formed on the front surface 15a. Using different diffraction orders, the CGH 16 performs two focusing functions: it focuses the reflected monitor light 13a onto the photodetector 14a, and focuses the remaining transmitted light 13b into the core of the optical fiber 12. In order for the transmitted light 13b to be focused with maximum efficiency, the CGH 16 is designed as a transmission CGH, and the transmitted light 13b is focused by first-order diffraction. The reflected monitor light 13a is focused by diffraction of a higher order.

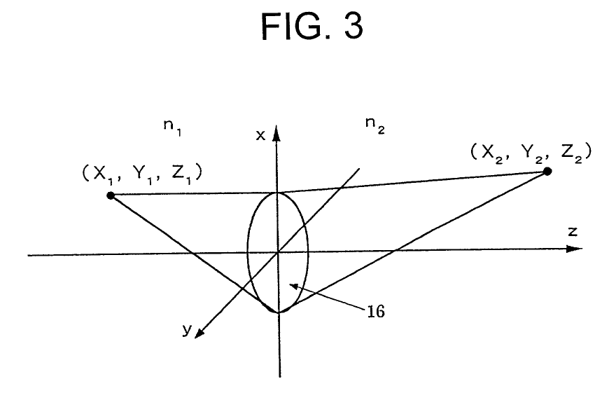

The focusing of the transmitted light 13b is illustrated schematically in FIG. 3. A Cartesian (x, y, z) coordinate system is used. The CGH 16 is disposed in the x-y plane (z=0). Because of the tilt of the CGH 16, the z-axis differs from the beam axis 13c shown in FIG. 2. The CGH 16 receives light from a point source at (X₁l, Y₁, Z₁), and focuses the light to a point image at (X₂, Y₂, Z₂). The two points are disposed on opposite sides of the CGH 16, (X₁, Y₁, Z₁) representing the output end of the semiconductor laser 11, (X₂, Y₂, Z₂) representing the input end of the optical fiber 12. The light is transmitted through media having a refractive index n₁ on the light-source side and a refractive index n₂ on the waveguide side.

If the thickness of the CGH 16 is small enough to be ignored, the optical path difference function ρ(x, y) for the transmitted light 13b can be expressed by the following equation.

ρ(x, y)=n₁·{(X₁−x)²+(Y₁−y)²+Z₁²}^{½-}n₁·L₁+n₂·{(X₂−x)²+(Y₂−Y)²+Z₂²}^{½-}n₂·L₂ (4)

where L₁ is the distance from the point source to the origin of the coordinate system and L₂ is the distance from the focal point to the origin. These distances are given by the following equations.

L₁=(X₁²+Y₁²+Z₁²)^{½} (5)

L₂=(X₂²+Y₂²+Z₂²)^{½} (6)

The first and second terms on the right side of equation (4) represent the two-dimensional optical path difference of a spherical wave front incident on the CGH 16 from a point source located at (X₁, Y₁, Z₁). The third and fourth terms on the right of equation (4) represent the two-dimensional optical path difference of a spherical wave front focused by the CGH 16 to a point image at (X₂, Y₂, Z₂).

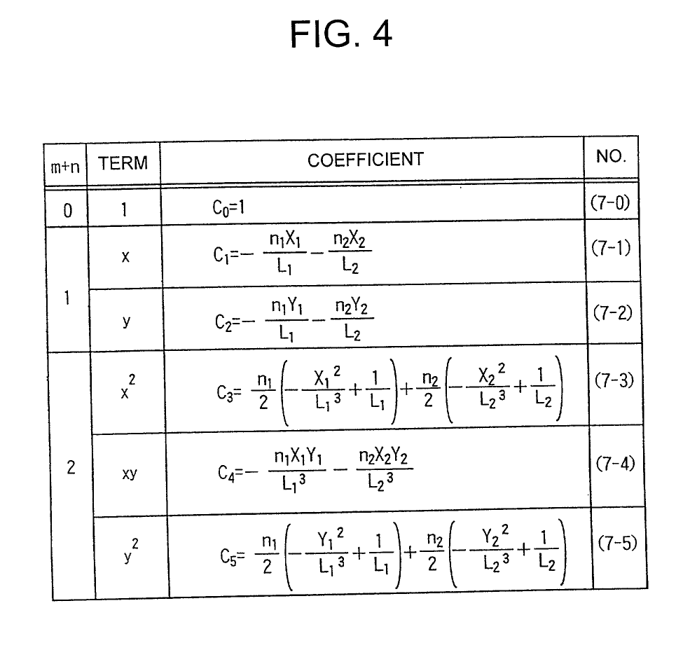

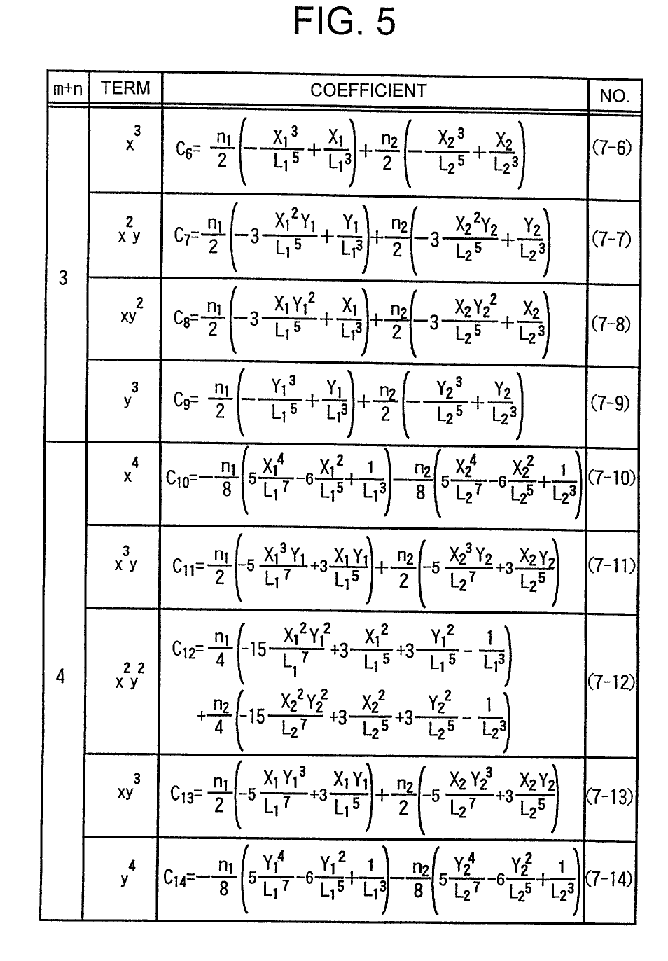

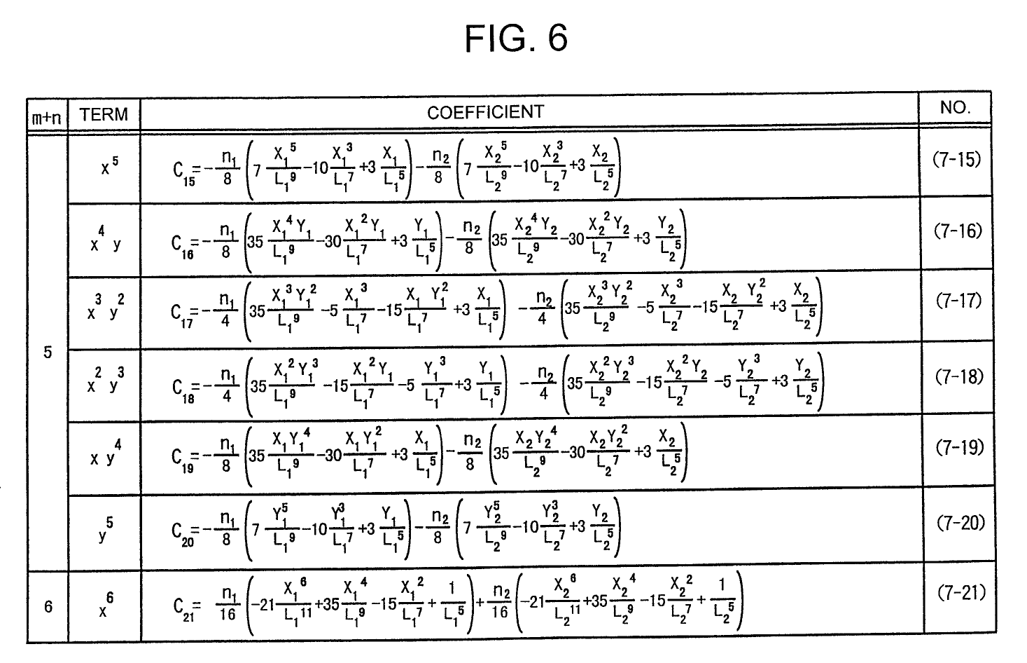

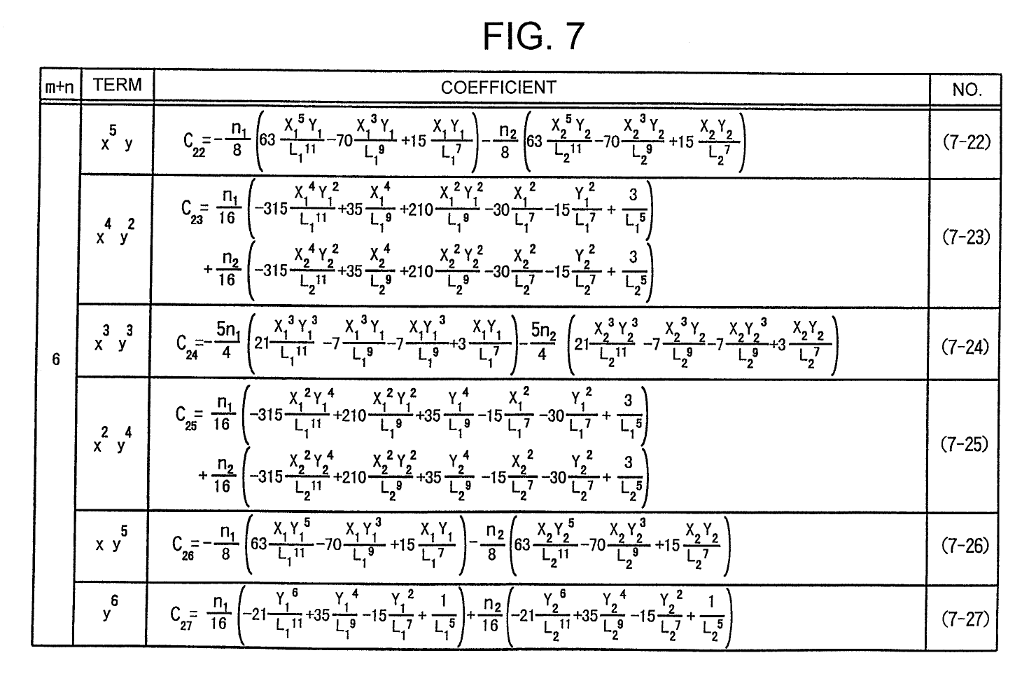

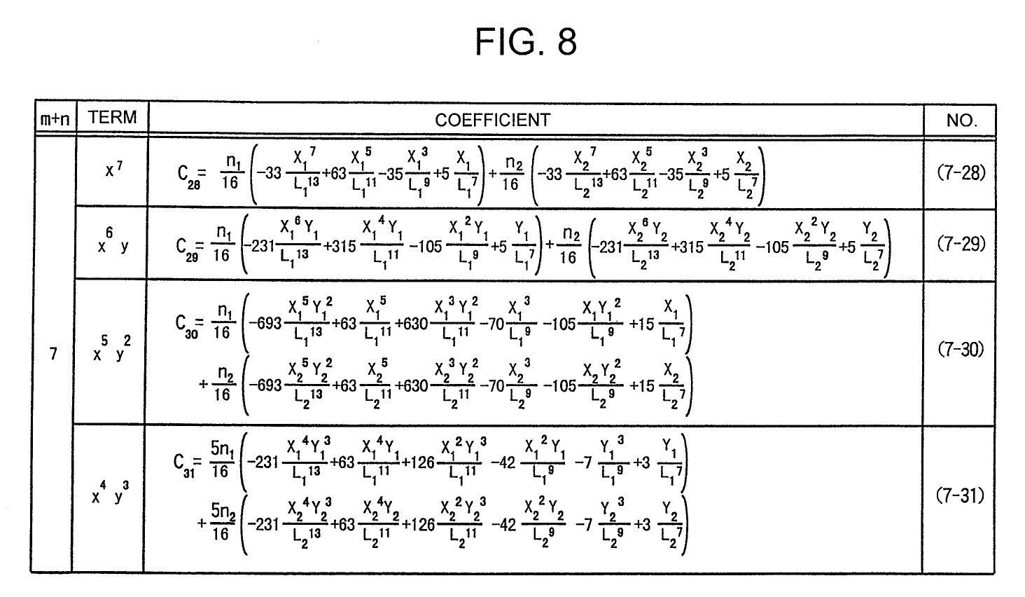

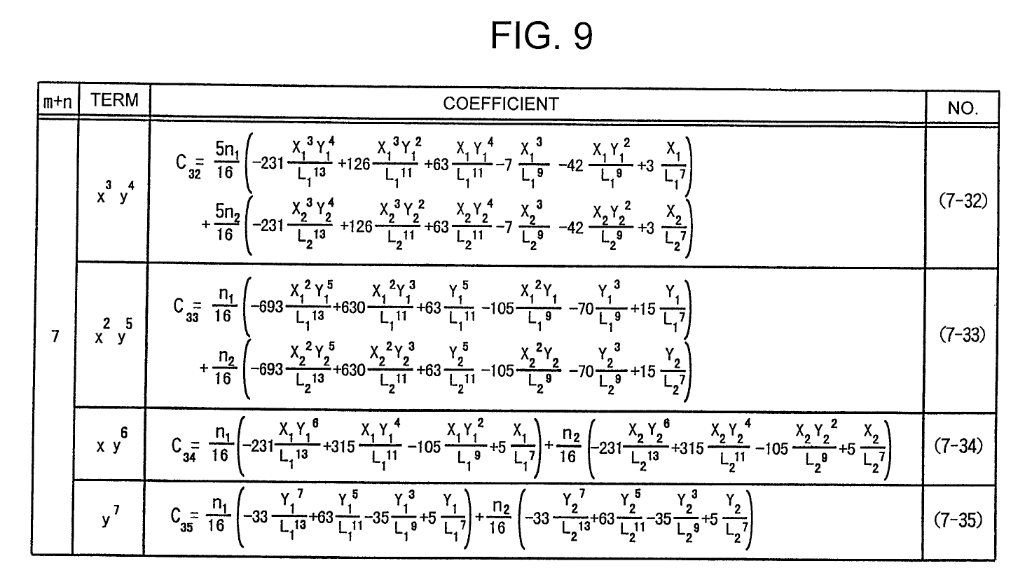

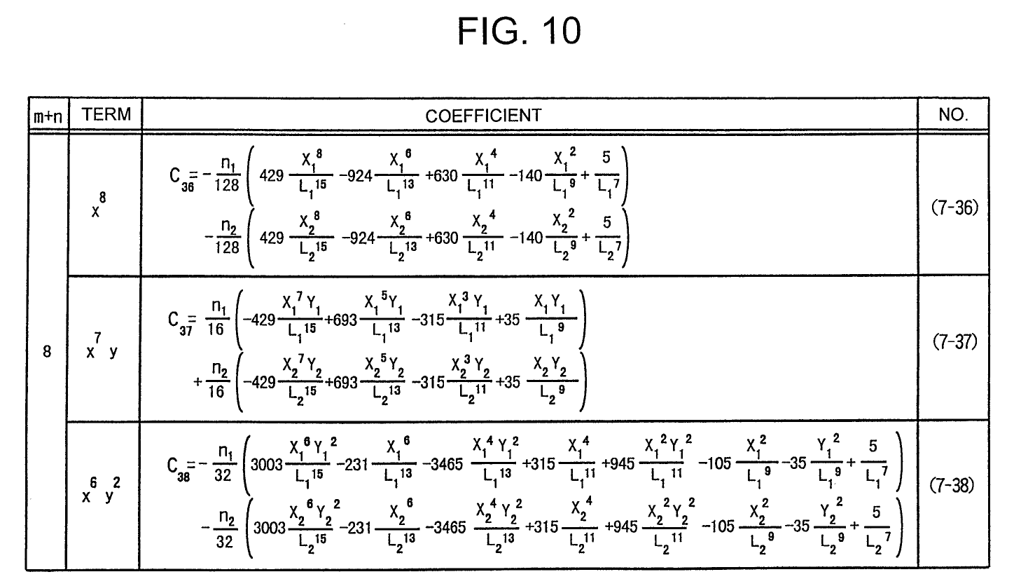

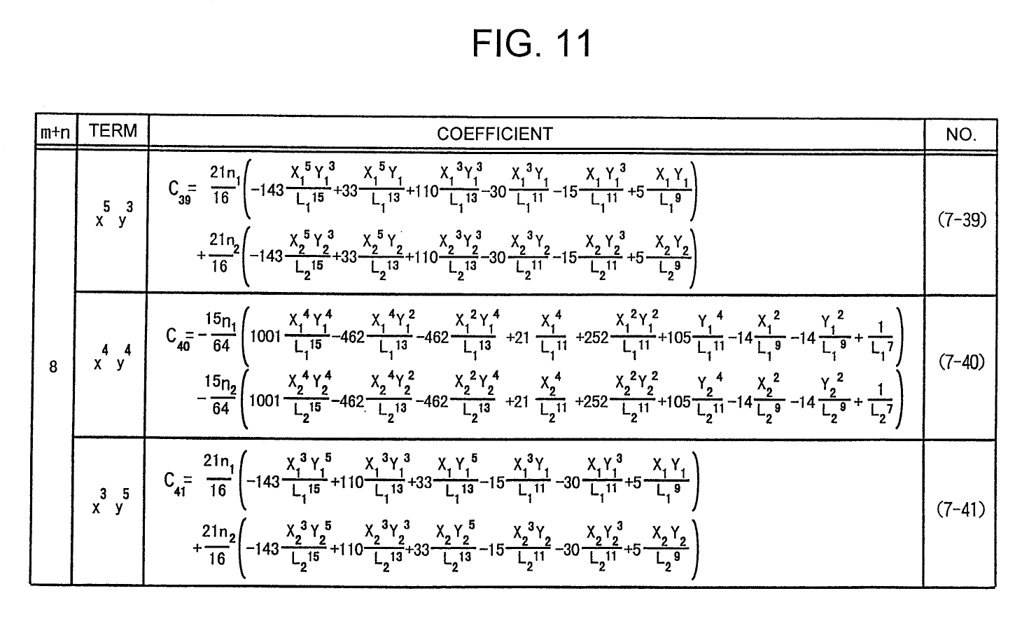

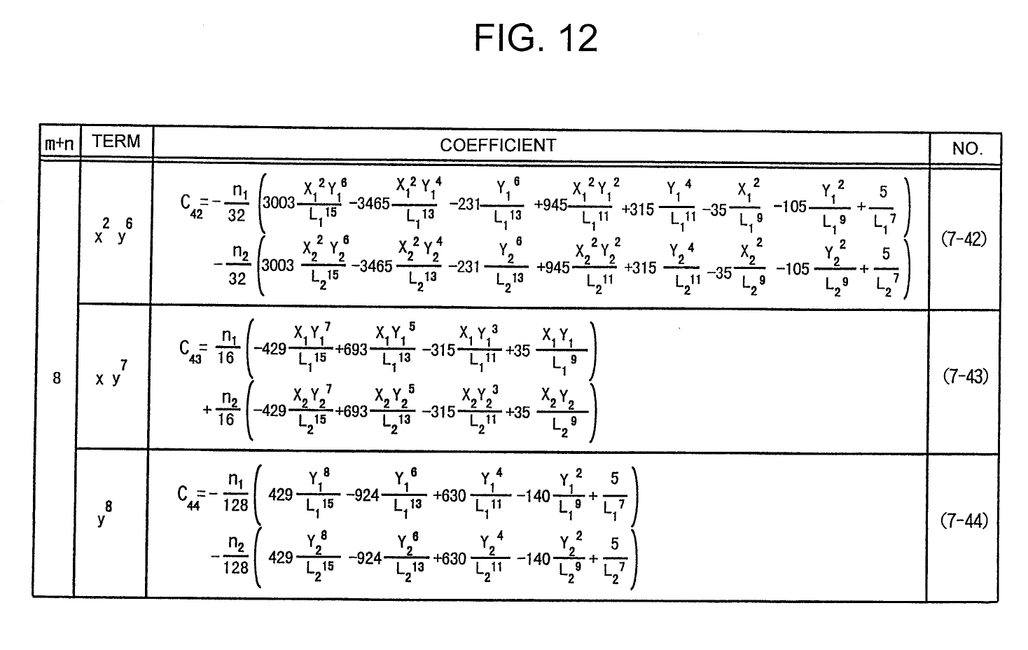

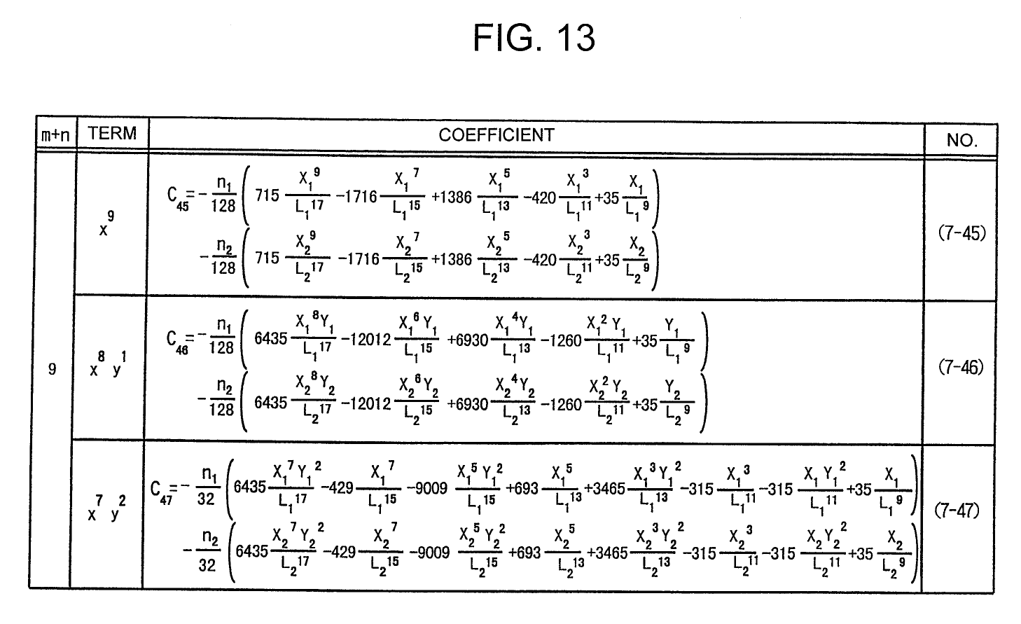

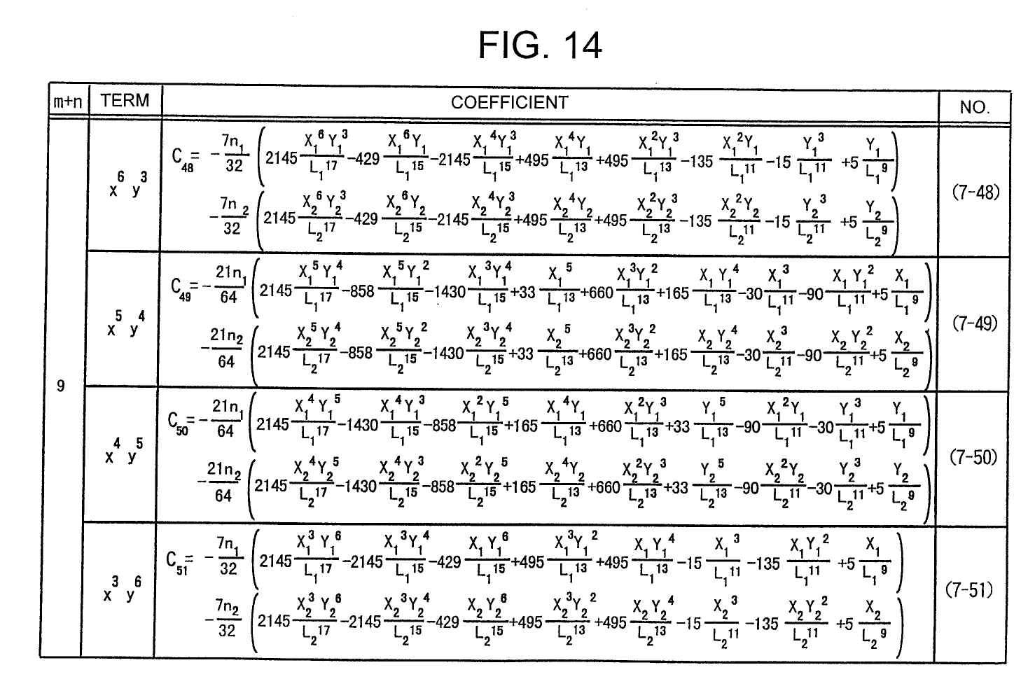

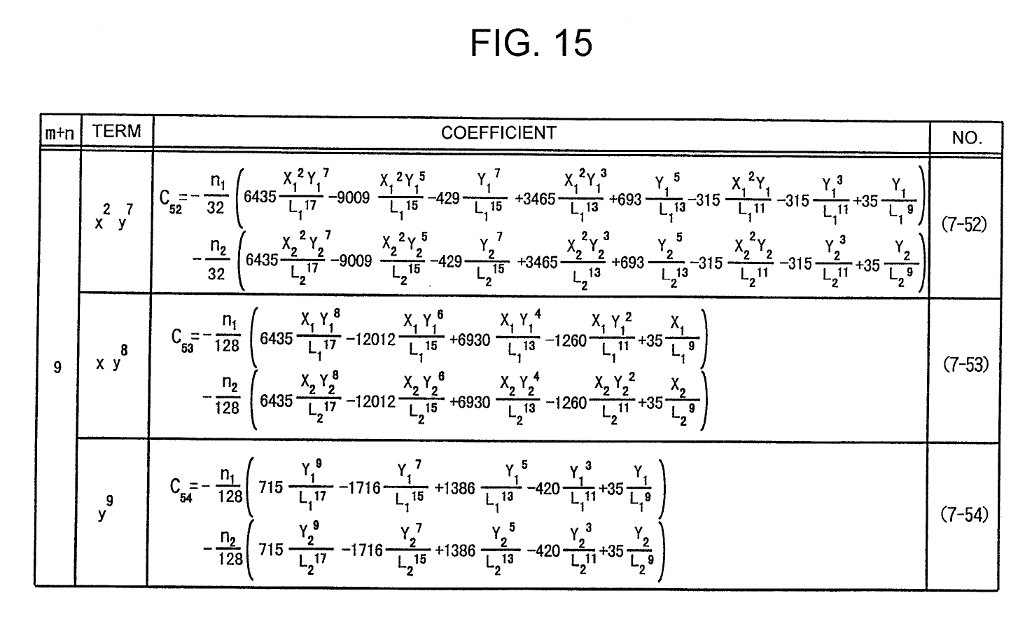

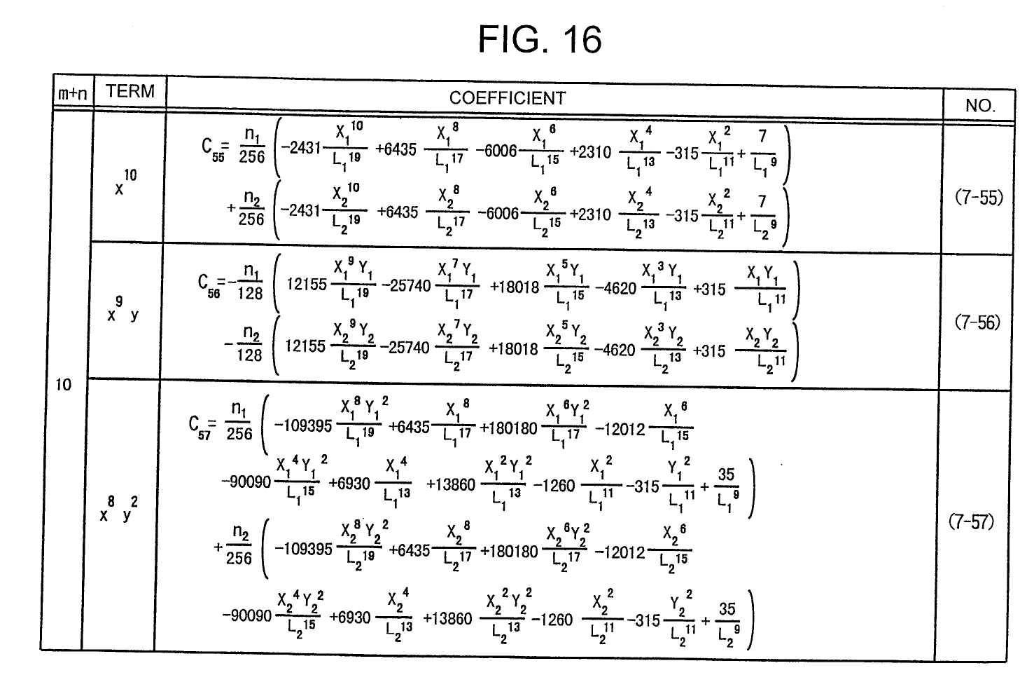

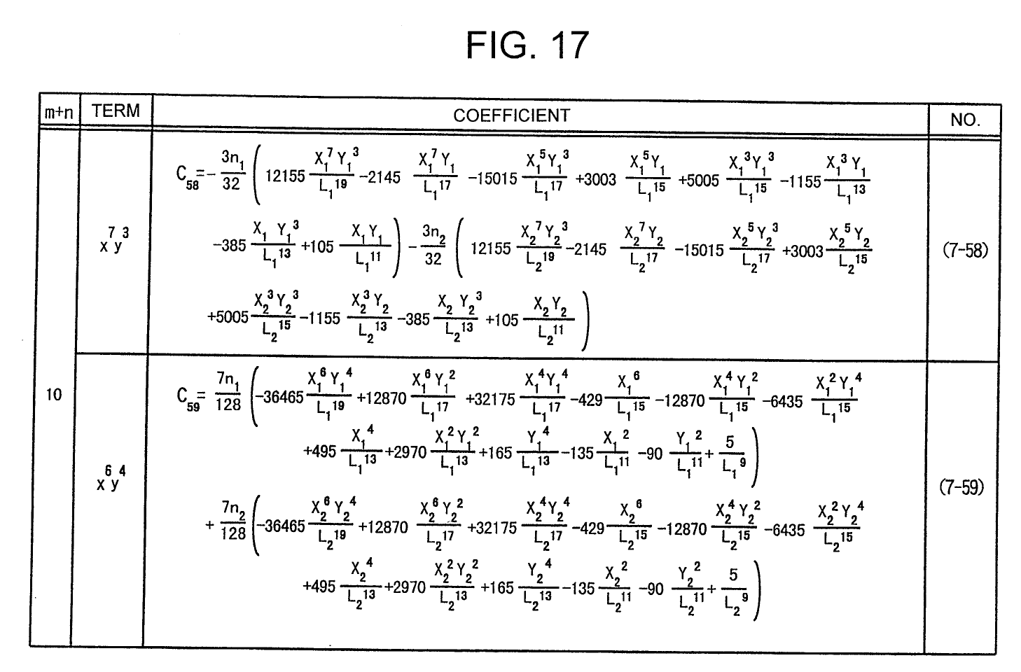

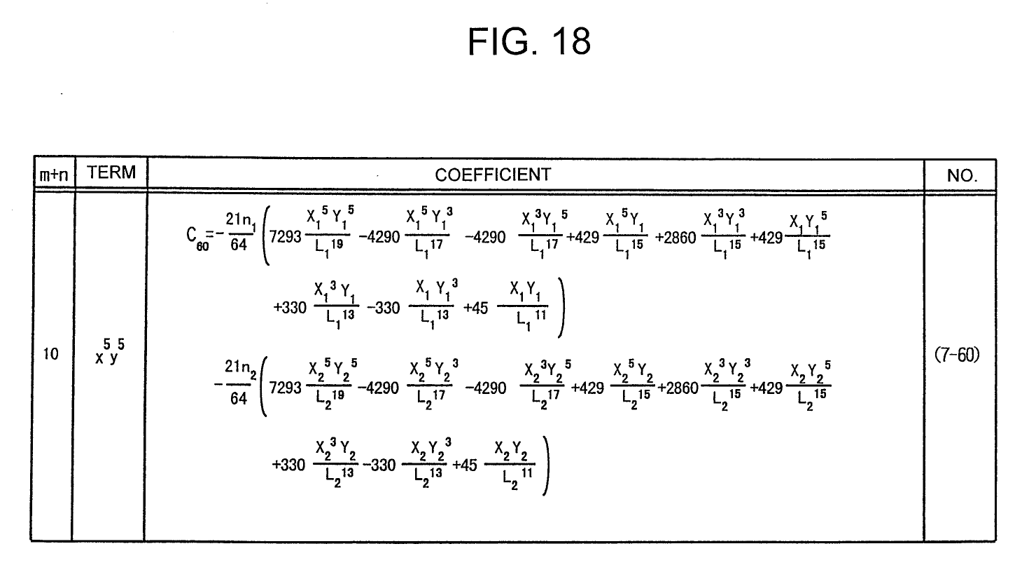

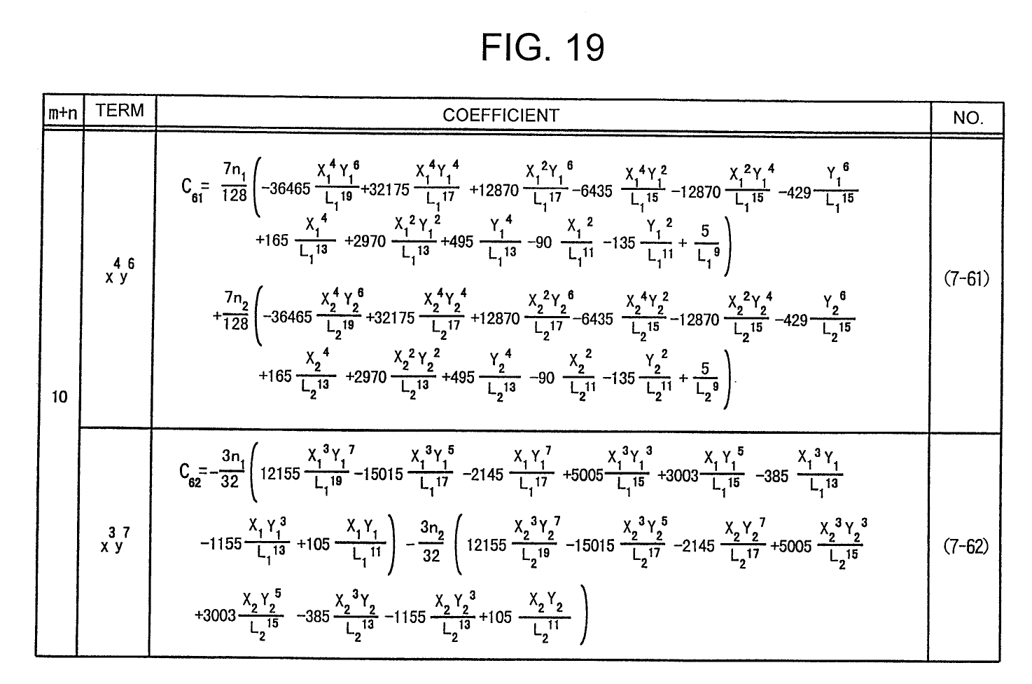

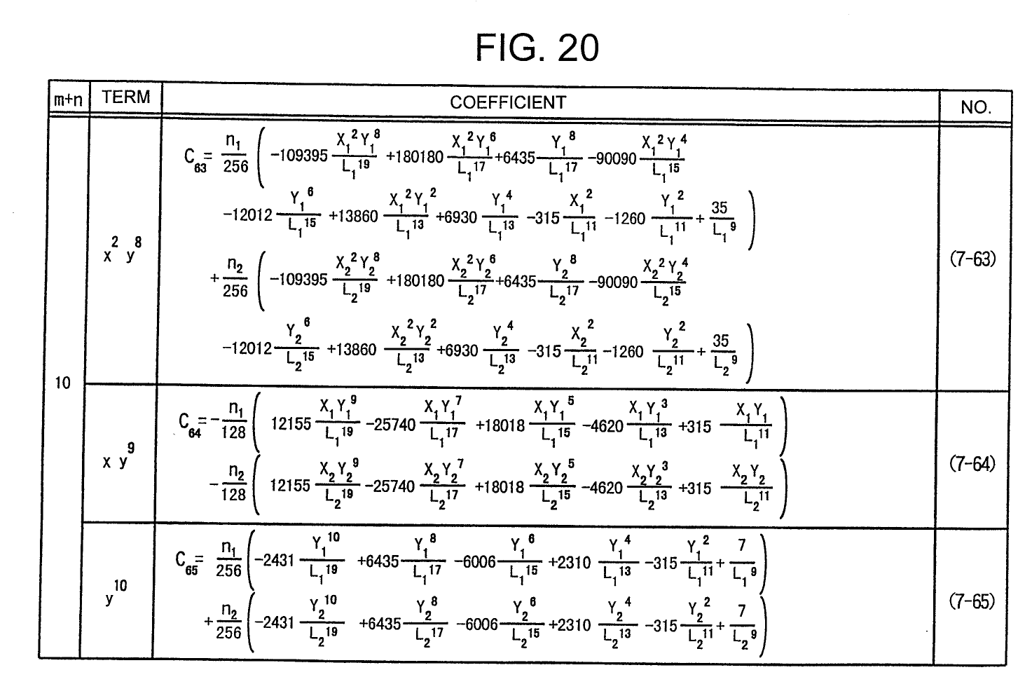

Formulas for the optical path difference coefficients C₀ to C_{N} can be obtained by substituting equation (4) into equation (3) and performing mathematical calculations. The formulas for C₀ to C₆₅ are shown in FIGS. 4 to 20 as equations (7-0) to (7-65). Substitution of the numerical values of X₁, Y₁, Z₁, X₂, Y₂, Z₂, L₁, L₂, n₁, and n₂ into these formulas gives numerical values of the coefficients C₀ to C₆₅, which the above-mentioned CGH CAD program uses to generate mask data for photolithography and etching.

If the optical path difference function ρ(x, y) describes a hologram equivalent to a lens with a single convex region, the minimum line width of the mask patterns that will be generated can be calculated by evaluating the following formula at the boundary of the hologram. This formula gives the line-width dimensions P in the vicinity of a point (x, y) in terms of the number of phase levels (N_{X}) and the wavelength X of the light emitted by the light source 11.

P=λ/{N_{X}·|gradρ(x, y)|} (8)

Whether the optical path difference function ρ(x, y) given by equation (4) describes a single convex lens area or not can be determined by an application of the method used to determine the minimum and maximum values of an arbitrary function y=f(x). The method involves calculation of the second partial derivatives of the optical path difference function ρ(x, y) with respect to x and y. A single convex area exists if neither of these partial derivatives takes on a negative or zero value.

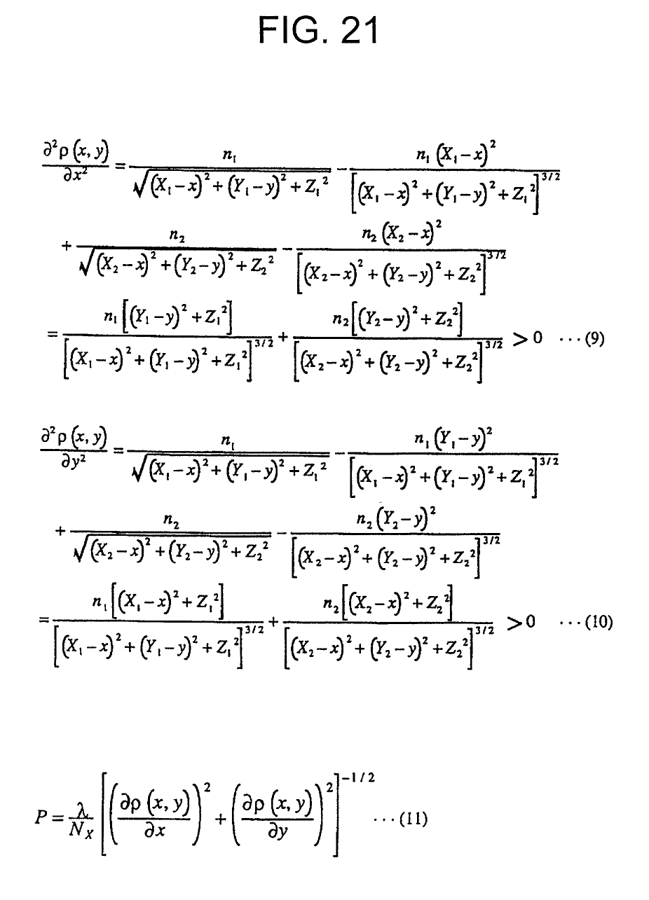

The second partial derivatives of the optical path difference function ρ(x, y) are given by equations (9) and (10) in FIG. 21. From these equations (9) and (10) it is clear that both second partial derivatives are always greater than zero, indicating the existence of a single convex area.

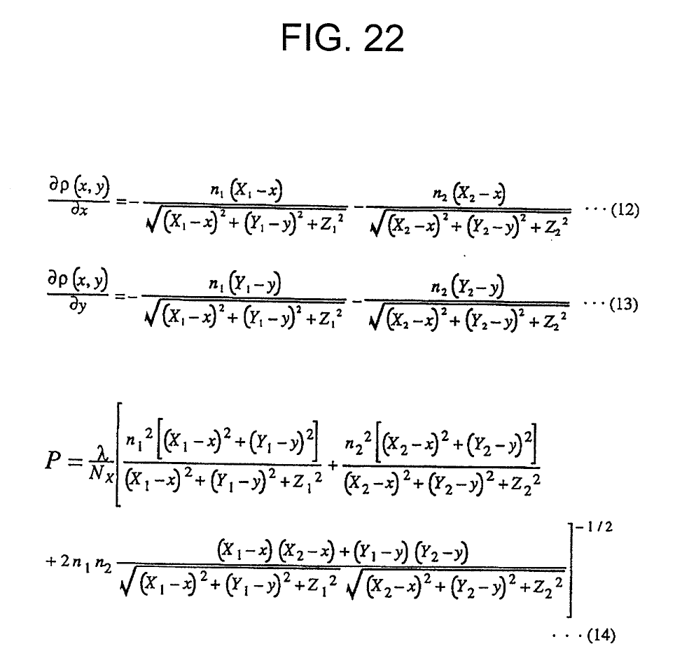

The minimum line-width dimension P of the mask patterns for creating the CGH given by equation (4) can therefore be calculated from equation (8). This equation (8) can be rewritten in the form shown in equation (11) in FIG. 21, involving the first partial derivatives of the optical path difference function ρ(x, y) with respect to x and y, which are given by equations (12) and (13) in FIG. 22. Substitution of equations (12) and (13) into equation (11) gives the result shown in equation (14) in FIG. 22.

If the minimum line-width dimension P derived in this way is equal to or greater than the tolerance allowed by the resolution of the photolithography process, then a diffractive optical element having optical characteristics described by the optical path difference function (4) can be manufactured without changing the lens design. That is, the CGH 16 can be manufactured. It will be assumed below that this tolerance condition is met with three masks (M=3) and eight phase levels (N_{X}=8).

Next, the amounts of monitor light 13a and transmitted light 13b that are focused onto the photodetector 14a and optical fiber 12 will be calculated. It will be assumed that the refractive index n of the optical plate 15 is 1.5, and that absorption of light by the optical plate 15 is small enough to be ignored.

When a beam of light propagating through space with a wavelength λ is incident on the surface of a flat plate having a refractive index n, Fresnel reflection occurs with a reflectivity R given by the following formula.

R={(n−1)/(n+1)}² (15)

If the refractive index n is 1.5, accordingly, the Fresnel reflectivity is four percent (4%).

Substantially all of the light that is not reflected by Fresnel reflection is transmitted through the optical plate 15, so the light transmitted by the CGH 16 is substantially ninety-six percent (96%) of the output light 13 incident on the optical plate 15. Not all of this light is focused by first-order diffraction, however, so to determine the amount of light coupled into the optical fiber 12, the diffraction efficiency of the CGH 16 must be taken into account.

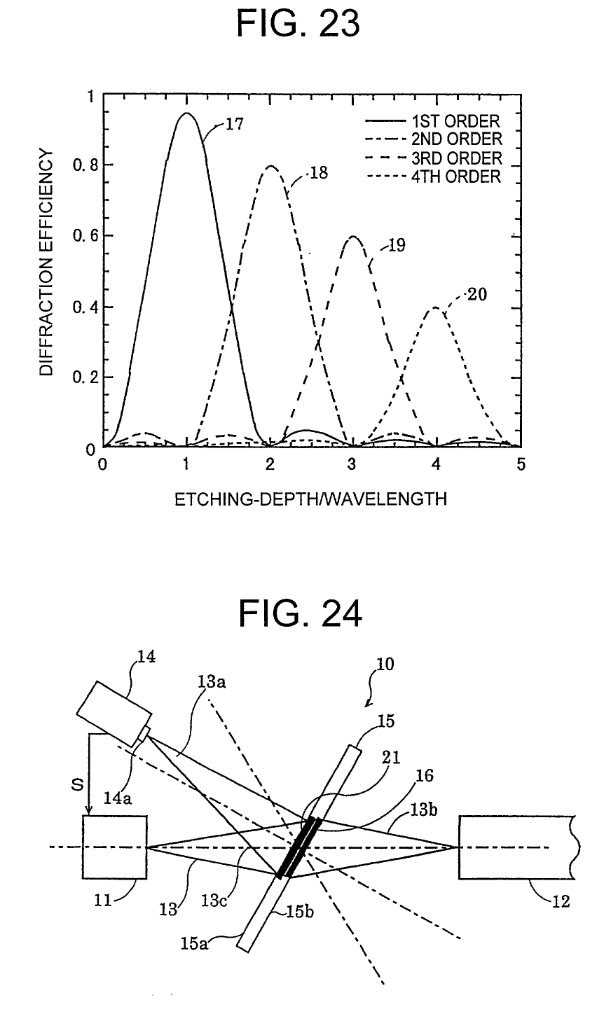

FIG. 23 shows the dependence of the diffraction efficiency on the CGH etching depth and the wavelength of the diffracted light when there are eight phase levels (N_{X}=8). The vertical axis indicates the diffraction efficiency. The horizontal axis indicates the ratio of the etching depth to the wavelength. The solid curve 17 indicates the first-order diffraction efficiency. The dashed and dotted curves 18, 19, 20 indicate second-order, third-order, and fourth-order diffraction efficiency, respectively. The ratio of etching depth to wavelength that yields the maximum first-order diffraction efficiency is equal to unity.

A comparison of these diffraction efficiency curves 17, 18, 19, 20 shows that the first-order diffraction efficiency curve 17 has the highest peak. When the CGH 16 is fabricated, the etching depth is controlled to obtain this peak diffraction efficiency. As a result, substantially ninety-five percent (95%) of the light transmitted by the CGH 16 is focused into the optical fiber 12. Since this transmitted light is substantially 96% of the output light 13, the transmitted light 13b coupled into the optical fiber 12 is substantially 91% (96%×95%≈91%) of the output light 13.

For holographic transmission, the diffraction depth T_{Transmission} that yields the maximum first-order diffraction efficiency is related to the wavelength λ of the light emitted by the semiconductor laser 11, the refractive index n of the optical plate 15, and the number of masks N_{X} as follows.

T_{Transmission}={λ/(n−1)}·{(N_{X}−1)/N_{X}} (16)

For holographic reflection, the diffraction depth T_{Reflection} that yields the maximum first-order diffraction efficiency is related to the wavelength λ and the number of masks N_{X} as follows.

T_{Reflection}=(λ/2)·{(N_{X}−1) /N_{X}} (17)

These two etching depths are therefore related as follows.

T_{Transmission}/T_{Reflection}=2/(n−1) (18)

In the present case, in which the refractive index of the optical plate 15 is equal to 1.5 (so n−1=0.5), the etching depth is too great by a factor of four, in relation to the wavelength λ, to achieve maximum first-order diffraction efficiency by reflection. As the dotted curve 20 in FIG. 23 shows, however, a fourth-order diffraction efficiency peak of substantially 0.4 occurs at precisely this ratio of the etching depth to the wavelength λ. In the present embodiment, therefore, the reflected light focused by fourth-order diffraction is used as the monitor light 13a. Since the Fresnel reflectivity is four percent (R=4%), substantially 1.6 percent (0.4×4%=1.6%) of the light incident on the CGH 16 is focused onto the photodetector 14a as monitor light 13a.

Due to the very precise fabrication of the CGH 16, a high proportion (e.g., 91%) of the light emitted by the semiconductor laser 11 can be focused accurately into the optical fiber 12.

Due also to the high fabrication precision, monitor light 13a is focused accurately onto the photodetector 14a, and the ratio of the monitor light 13a to the transmitted light 13b is highly uniform, not varying from one optical device 10 to another. A consequent advantage is that the control unit 14 does not have to be adjusted separately for each optical device 10. Moreover, the control unit 14 does not have to be adjusted separately for each semiconductor laser 11, because the monitor light 13a is obtained directly from the output light 13.

Another advantage is that the optical device 10 is fabricated as a single unit, and does not have separate optical components requiring axial alignment. It is only necessary to ensure that the optical plate 15 is positioned correctly in relation to the semiconductor laser 11, and that the optical fiber 12 and photodetector 14a are positioned correctly in relation to the optical plate 15.

A further advantage, as mentioned above, is that the tilt of the optical plate 15 prevents any emitted light 13 from being reflected back into the semiconductor laser 11. Thus it is not necessary to apply an antireflection coating to the optical device 10 to prevent reflected light from disrupting the coherence of light inside the semiconductor laser 11.

In the preceding description, since the refractive index n of the optical plate 15 was 1.5, fourth-order diffraction was used to focus the monitor light 13a, but it is possible to employ other diffraction orders: for example, ±1, ±2, or ±3. Once the CGH 16 has been designed for maximum first-order diffraction efficiency of the transmitted light 13b, the focal distance and direction of the reflected light of each diffraction order is uniquely determined. The reflective diffraction order that enables the photodetector 14a to be most conveniently positioned should be used.

Referring now to FIG. 24, in a second optical device 10 embodying the present invention, the transmission-type CGH 16 is located on the back surface 15b of the optical plate 15, and a reflection-type CGH 21 is disposed on the front surface 15a. Part of the output light 13 emitted by the semiconductor laser 11 is reflected from the front surface 15a of the optical plate 15 by Fresnel reflection. This light is focused by first-order diffraction in the reflection-type CGH 21 onto the photodetector 14a as monitor light 13a.

A reflection-type CGH, like a transmission-type CGH, reflects part of the incident light and transmits the rest. The larger part of the output light 13 passes through the CGH 21 without being reflected. Most of this light undergoes zero-order diffraction in the CGH 21; that is, it passes through the front surface 15a of the optical plate 15 as if the reflection-type CGH 21 were not present. The zero-order diffracted light is then focused toward the input end of the optical fiber 12 as described in the preceding embodiment, by first-order diffraction in the transmission-type CGH 16.

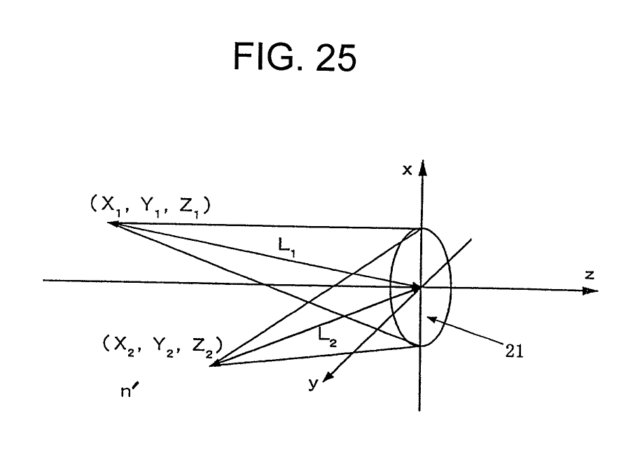

The focusing of the reflected monitor light 13a is illustrated schematically in FIG. 25. A Cartesian coordinate system is used in which the CGH 21 is disposed in the x-y plane (z=0). The CGH 21 receives light from a point source at (X₁, Y₁, Z₁), representing the emitting facet of the semiconductor laser 11, and focuses the light to an image at a point (X₂, Y₂, Z₂), representing the surface of the photodetector 14a. Both of these points are disposed on the same side of the CGH 21. The refractive index of the medium through which the light is transmitted on this side, which was denoted n₁ before, will now be denoted n′.

The refractive index of the optical plate 15 is 1.5, as in the preceding embodiment.

If the thickness of the CGH 21 is small enough to be ignored, the optical path difference function ρ(x, y) for the reflected light can be expressed by the following equation.

ρ(x, y)=(n′/2)·{(X₁−x)²+(Y₁−y)²+Z₁²}^{½}−(n′/2)·L₁+(n′/2)·{(X₂−x)²+(Y₂−y)²+Z₂²}^{½}−(n′/2)·L₂ (19)

where L₁ is the distance from the point source to the origin of the coordinate system and L₂ is the distance from the focal point to the origin. These distances are again given by the following equations.

L₁=(X₁²+Y₁²+Z₁²)^{½} (20)

L₂=(X₂²+Y₂²+Z₂²)^{½} (21)

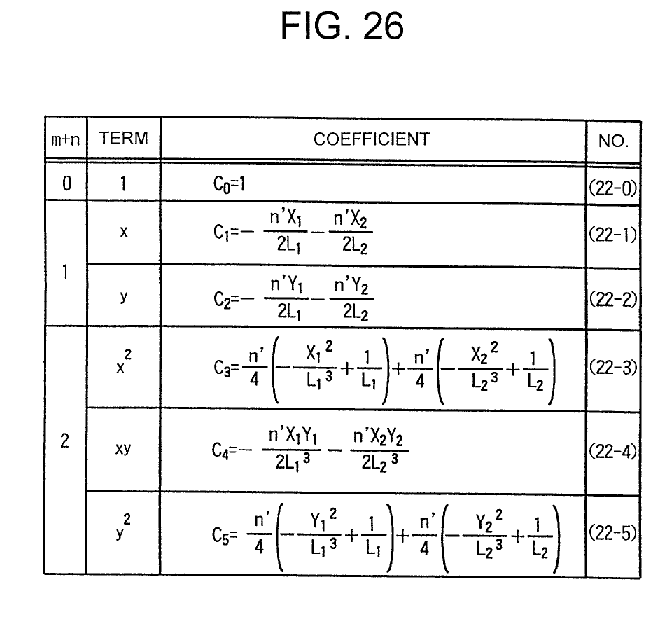

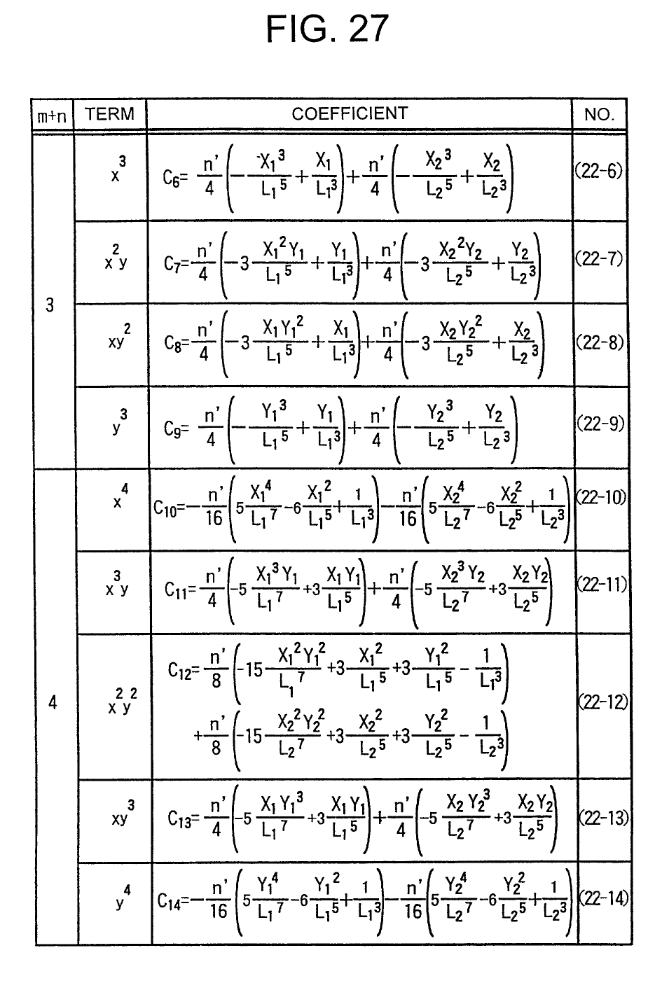

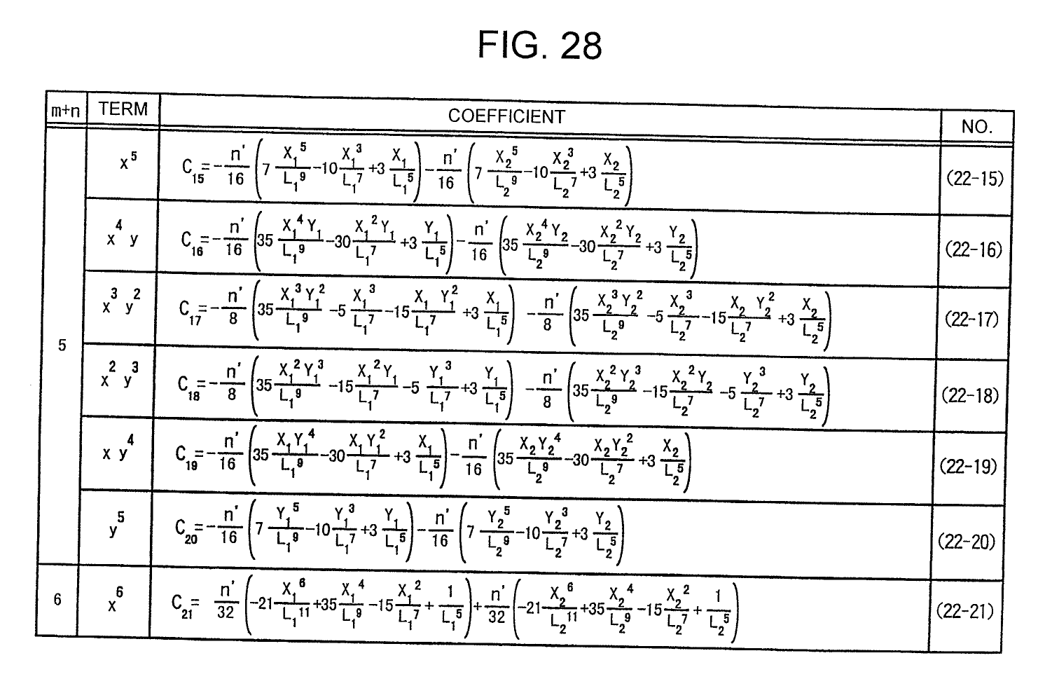

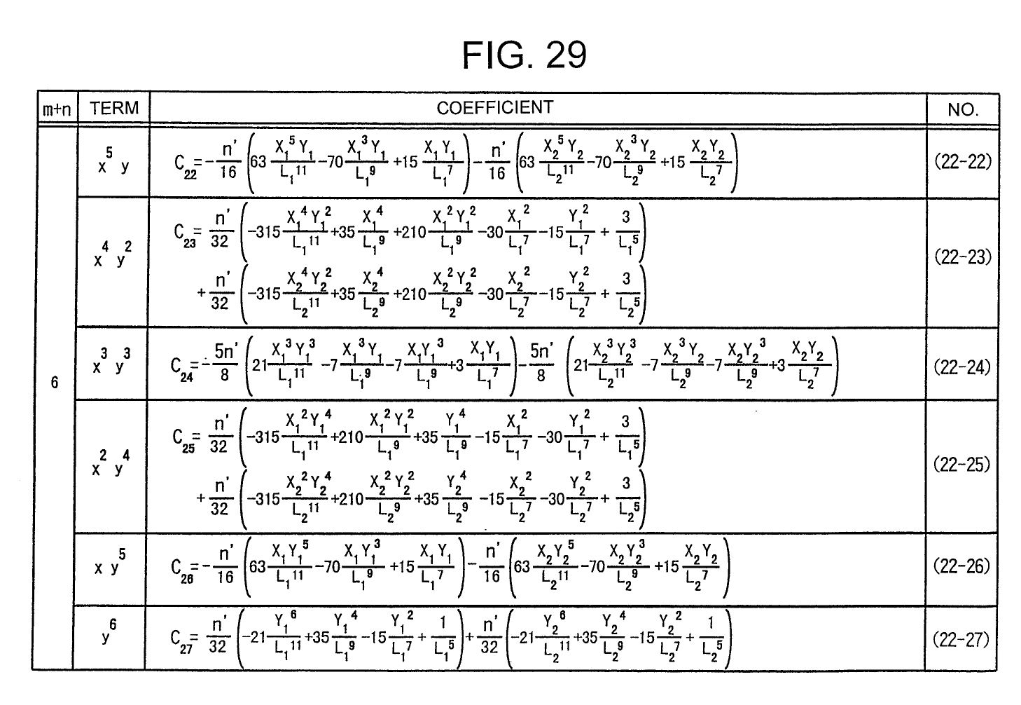

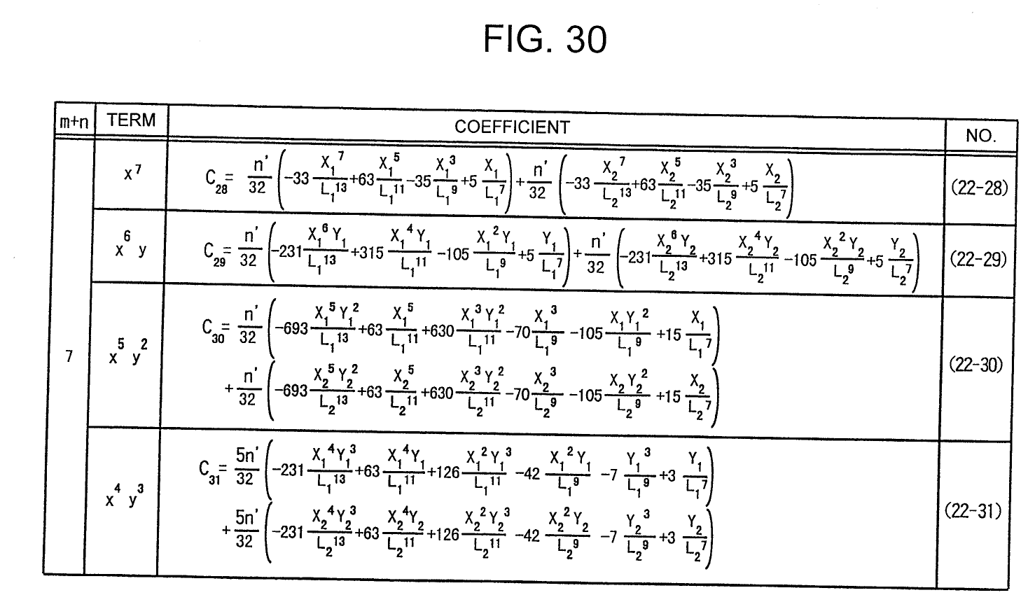

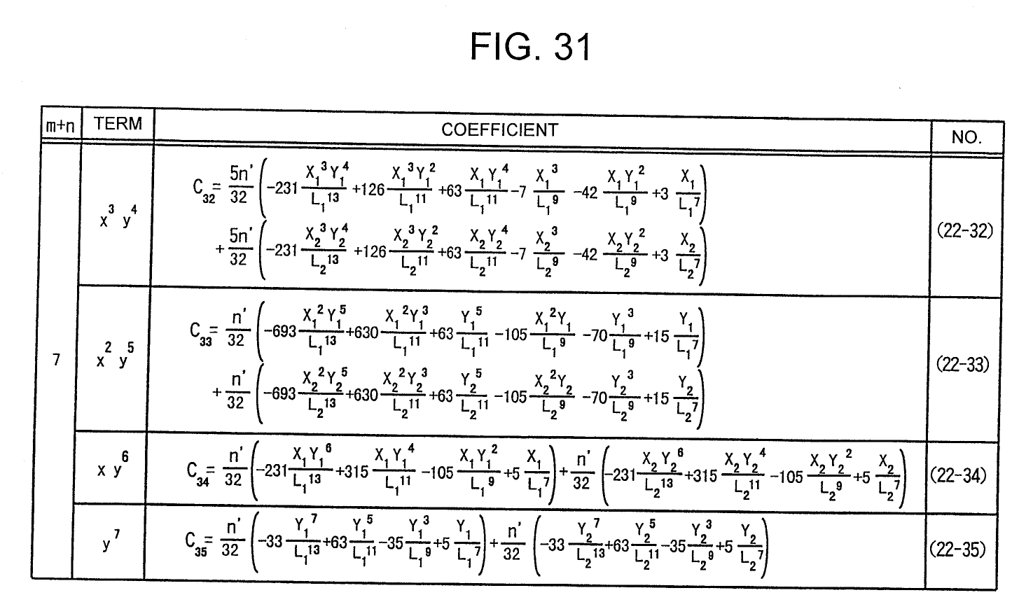

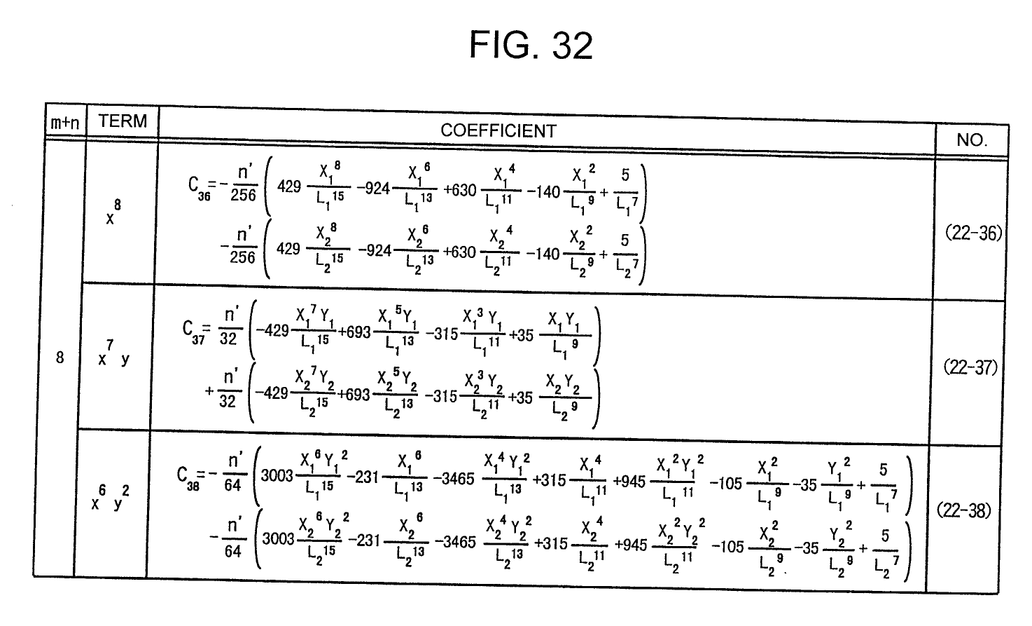

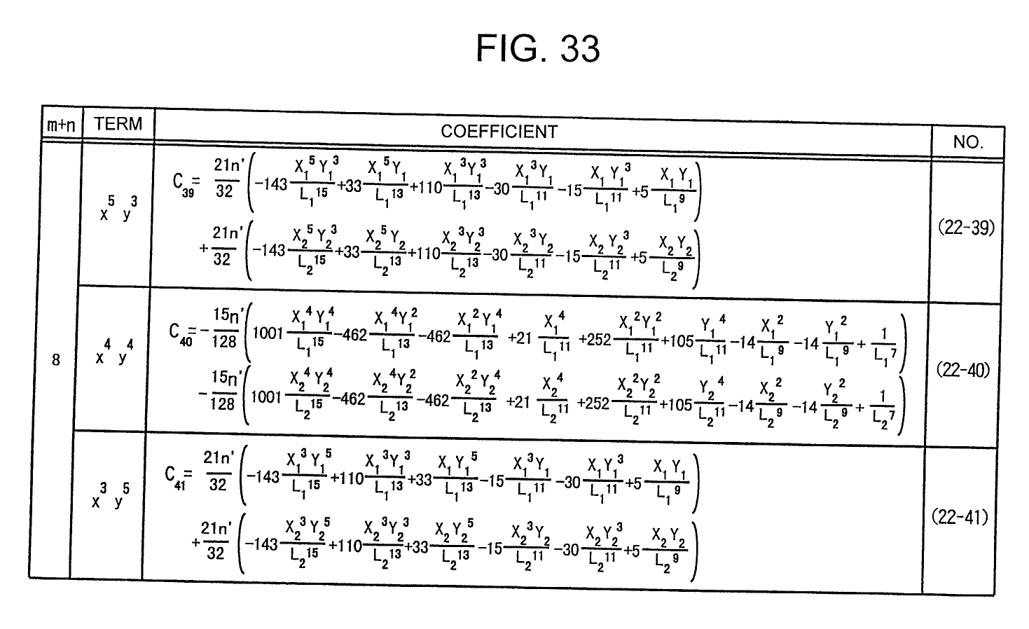

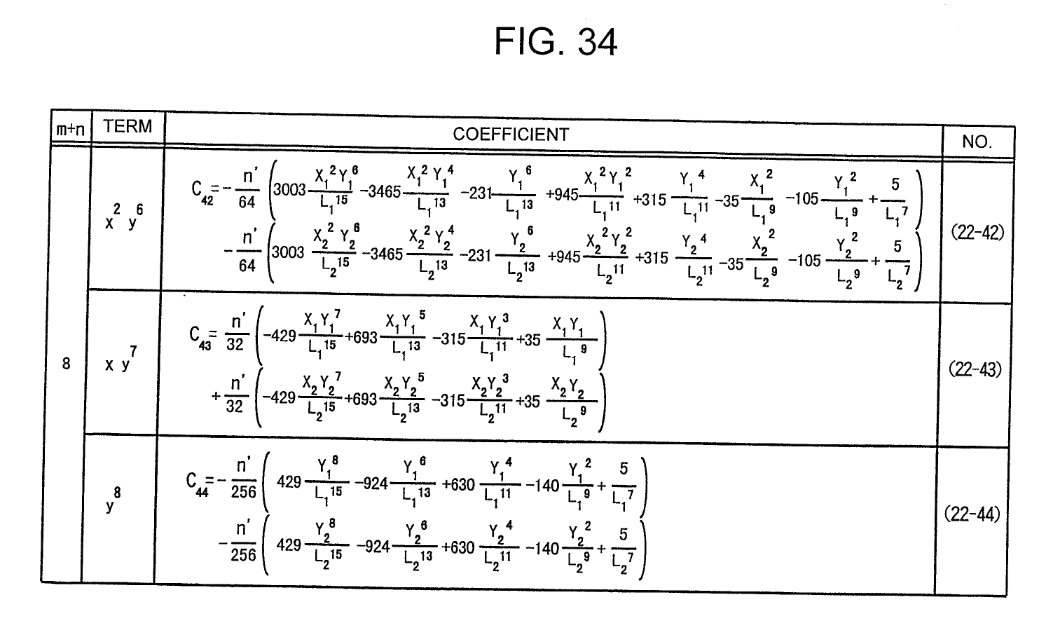

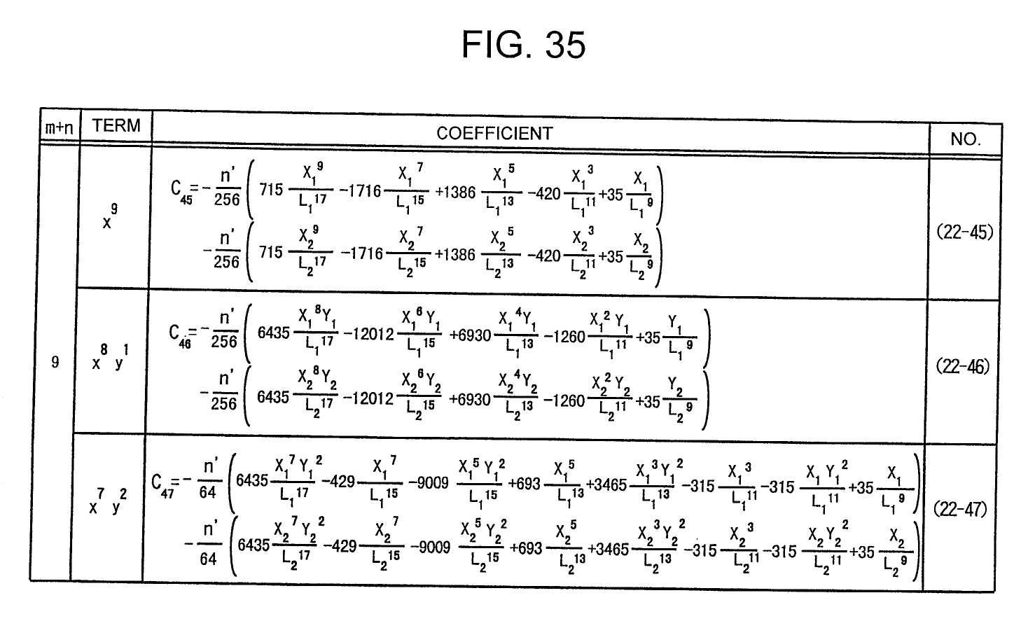

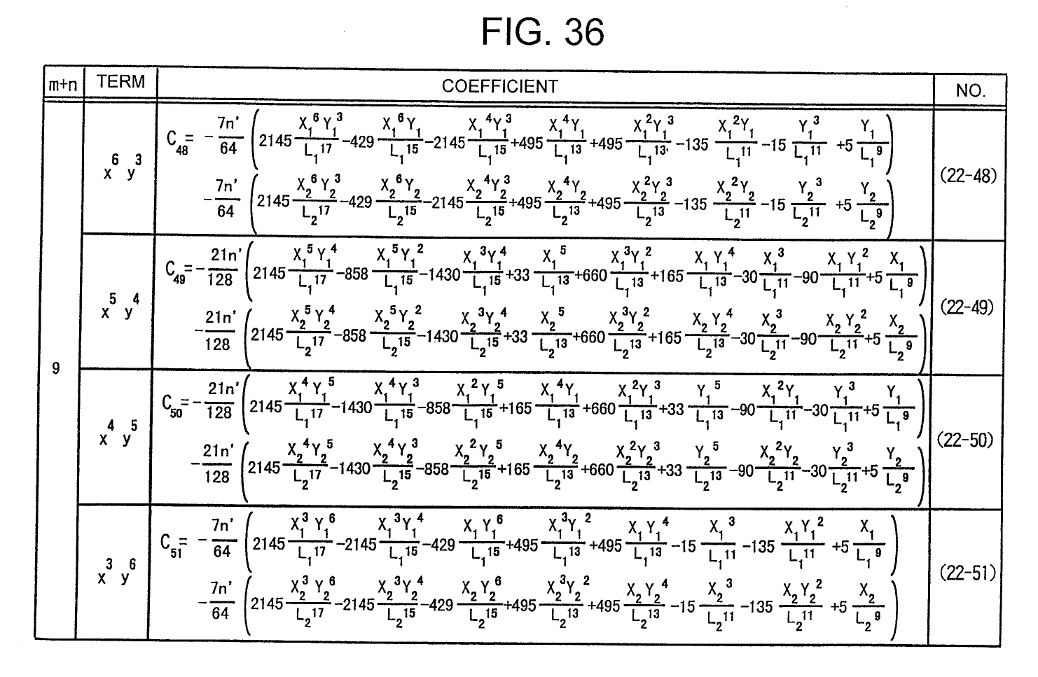

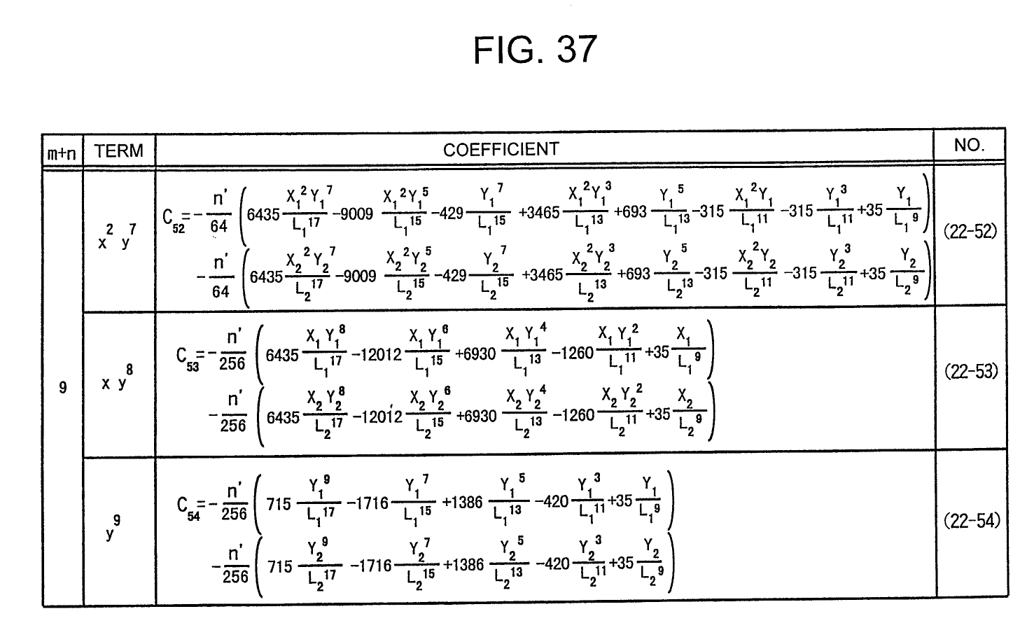

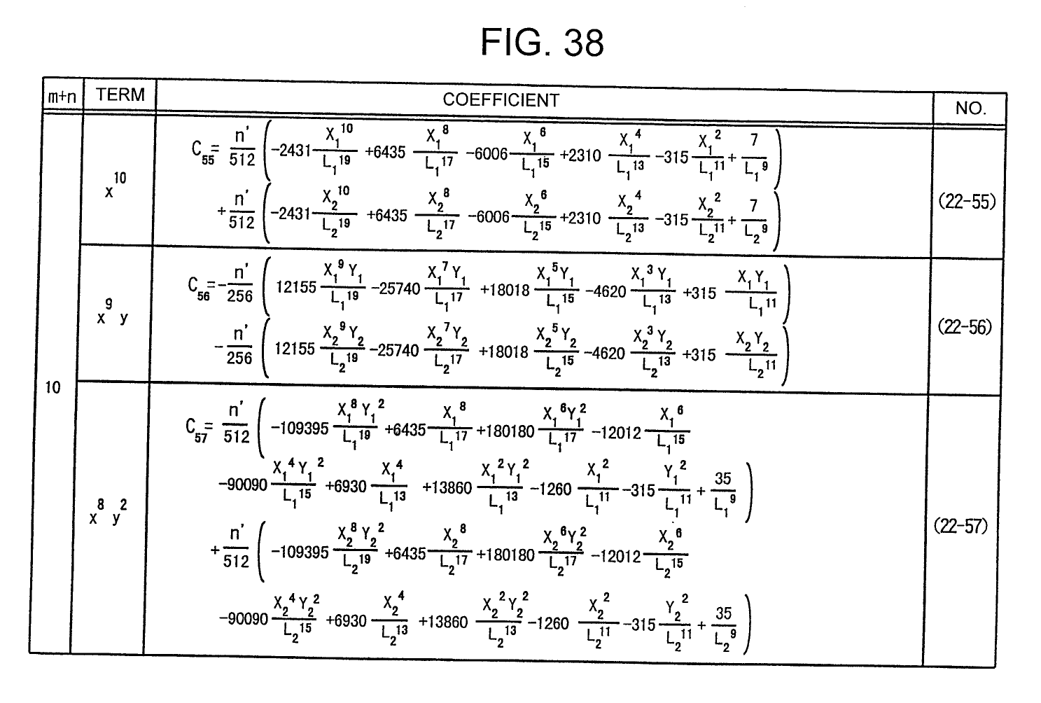

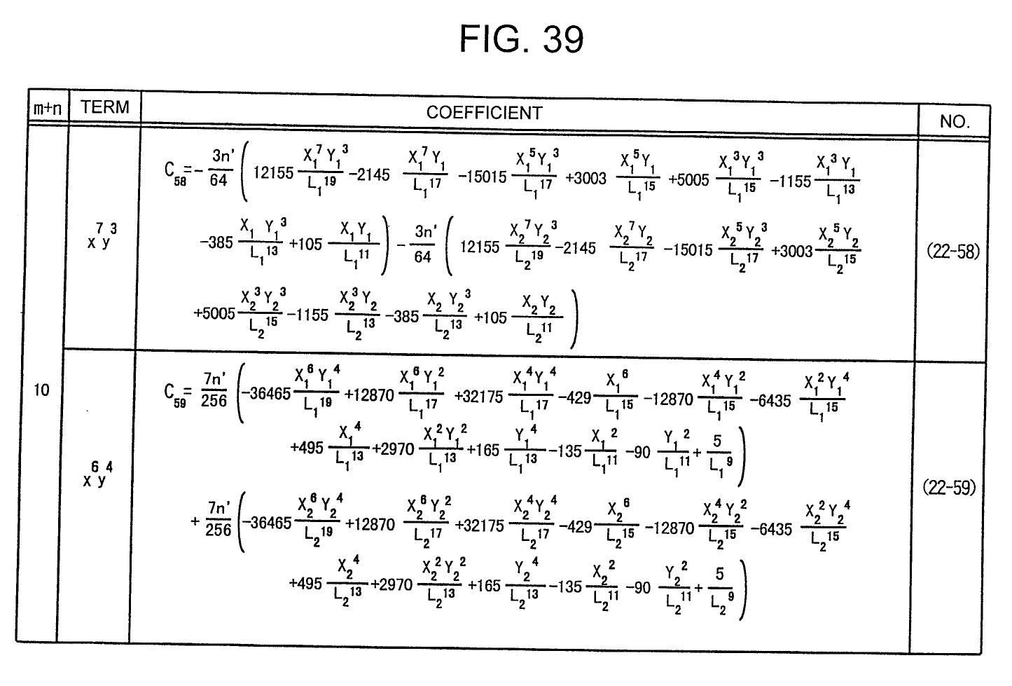

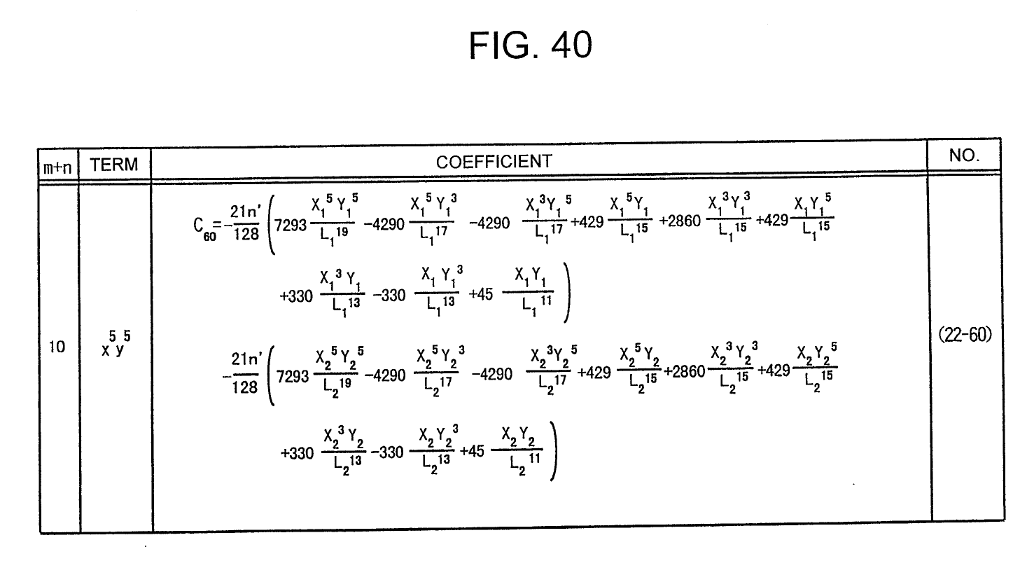

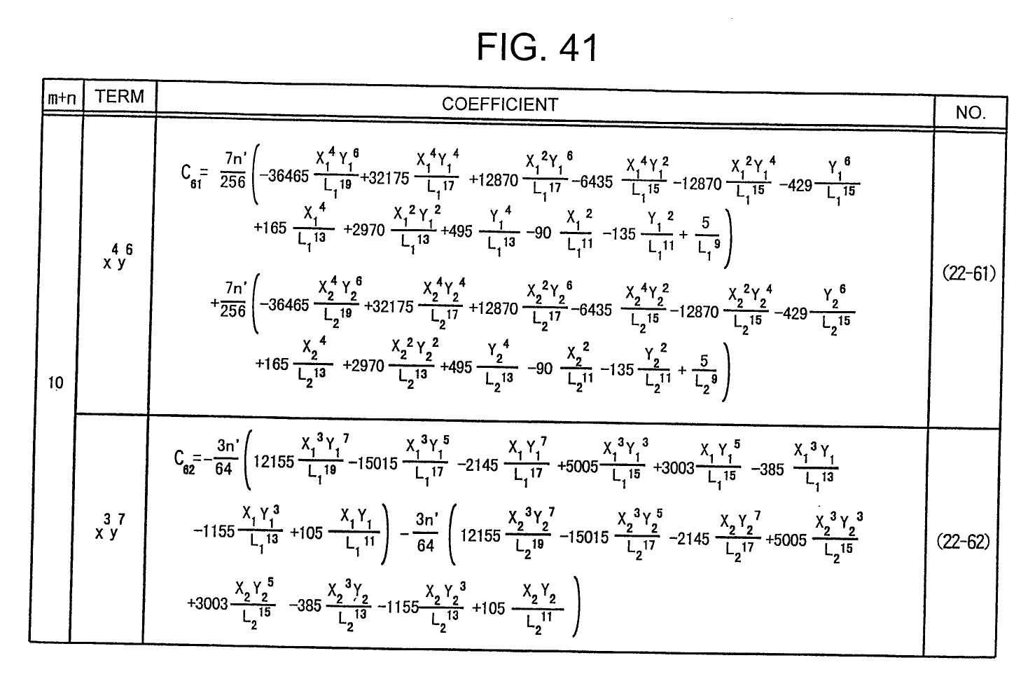

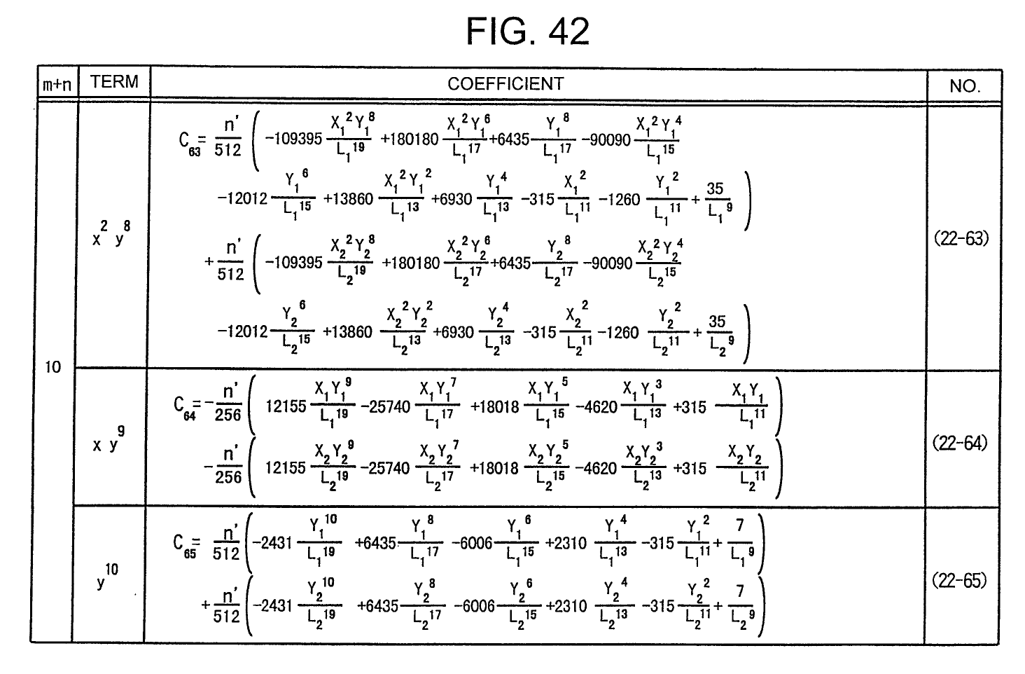

Equation (19) is similar to equation (4) except that only one refractive index n′ is involved, and the index is divided by two (n′/2) in order to generate a reflection-type hologram. Formulas for the optical path difference coefficients C₀ to C_{N} of this hologram 21 can be obtained by substituting equation (19) into equation (3) and performing mathematical calculations. The resulting formulas for C₀ to C₆₅ are shown as equations (22-0) to (22-65) in FIGS. 26 to 42. Numerical values obtained by evaluation of these formulas can be provided to the above-mentioned CGH CAD program to obtain mask data for photolithography and etching to create the reflection-type CGH 21.

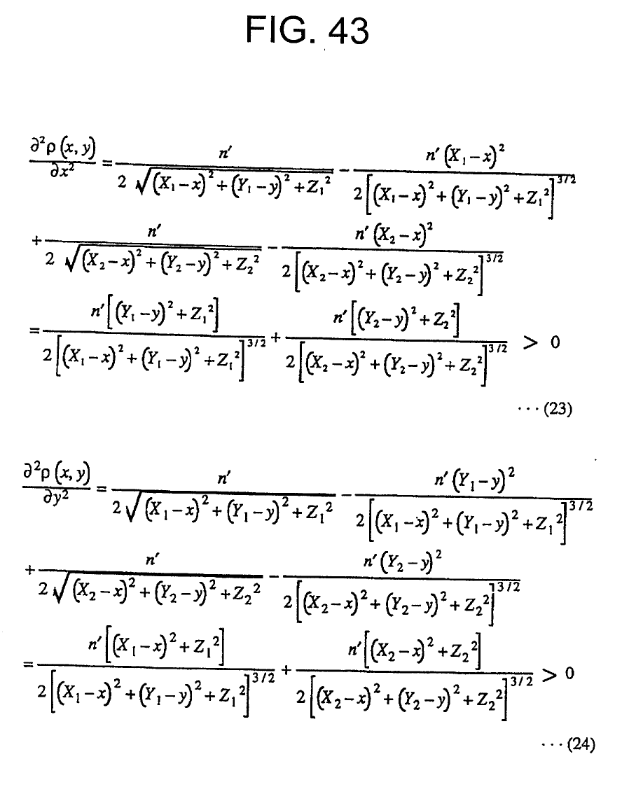

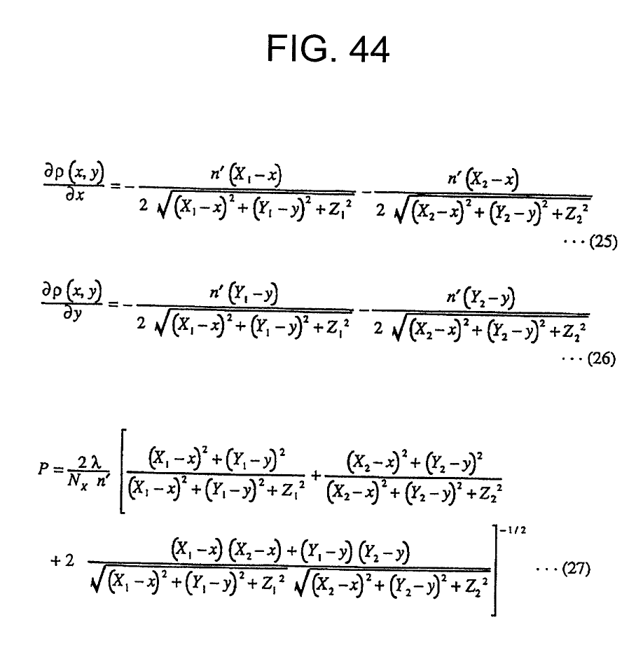

The second partial derivatives, with respect to x and y, of the optical path difference function ρ(x, y) given by equation (19) are shown as equations (23) and (24), respectively, in FIG. 43. These second partial derivatives are greater than zero for all values of x and y, so equation (19) is equivalent to the optical path difference function of a lens with a single convex region, and the minimum line-width dimension P of the mask patterns is given by equation (8) as described above. Referring to FIG. 44, since the first partial derivatives of equation (19) have the values given by equations (25) and (26), this dimension P can be determined from equation (27). The number of masks (M), thus the number of phase levels (N_{X}=2^{M}), should be selected so that this dimension P is not less than the tolerance allowed by the resolution of the photolithography process.

The amount of monitor light 13a focused by the reflection-type CGH 21 onto the photodetector 14a can be calculated by multiplying the first-order diffraction efficiency by the Fresnel reflectivity. The first-order diffraction efficiency is calculated in the same way as for a transmission-type hologram and is therefore substantially ninety-five percent (95%), as shown by the solid curve 17 in FIG. 23. Since the optical plate 15 has the same refractive index as in the preceding embodiment, the Fresnel reflectivity R is again four percent (4%). Accordingly, substantially 3.8% of the output light 13 is focused onto the photodetector 14a as monitor light 13a.

The amount of light transmitted through the CGH 21 by zero-order diffraction can be calculated as follows. The etching depth T_{Reflection} used to obtain the peak first-order diffraction efficiency of ninety-five percent for the reflected light is given by the following equation.

T_{Reflection}=(λ/2)·{(N_{X}−1)/N_{X}} (25)

The etching depth T_{Transmission} that would provide peak first-order diffraction efficiency for transmitted light is given by the following equation, in which n denotes the refractive index of the optical plate 15.

T_{Transmission}={(λ/(n−1)}·{(N_{X}−1)/N_{X}} (26)

The ratio between these two etching depths is given by the following equation.

T_{Reflection}/T_{Transmission}=(n−1)/2 (27)

Since the refractive index (n) of the optical plate 15 is 1.5, the ratio given by equation (27) is equal to 0.25. The ratio of the etching depth (T_{Reflection}) of the CGH 21 to the wavelength of the output light 13 is accordingly only one-quarter of the ratio that would give peak first-order diffraction efficiency for transmitted light. As indicated by the solid curve 17 in FIG. 23, at this 0.25 ratio, the first-order diffraction efficiency for the transmitted light is reduced to approximately nine percent (0.09). The sum of all higher-order diffraction efficiencies at this 0.25 ratio is approximately one percent (0.01). Thus the total amount of light transmitted through the CGH 21 that is diffracted by all non-zero diffraction orders is approximately ten percent (10%). The remaining ninety percent (90%) of the transmitted light undergoes zero-order diffraction, thus behaving as if the CGH 21 were not present. Since ninety-six percent (96%) of the incident light is transmitted through the CGH 21, the light transmitted with zero-order diffraction is approximately eighty-seven percent (87%) of the output light 13.

This light next encounters the transmission-type CGH 16 on the back surface 15b of the optical plate 15. As described earlier, the transmission-type CGH 16 transmits substantially ninety-six percent (96%) of the light it receives, with a first-order diffraction efficiency of substantially ninety-five percent (95%). The amount of light 13b transmitted with zero-order diffraction by the CGH 21 and then focused into the optical fiber 12 by first-order diffraction in the CGH 16 is thus substantially equal to eighty percent of the output light 13 (87%×96%×95%≈80%).

Compared with the first embodiment, the second embodiment couples somewhat less transmitted light 13b into the optical fiber 12, but provides more than twice as much monitor light 13a. Moreover, the focal point of the monitor light 13a is not restricted by the design of the transmission-type CGH 16. The reflection-type CGH 21 can be designed for any desired focal point. Thus the location of the photodetector 14a is not constrained.

Both holograms 16, 21 can be fabricated with high precision, so the second embodiment provides the same advantage of high uniformity as the first embodiment, with the additional advantage of greater design freedom.

In the second embodiment, the design of the transmission-type CGH 16 can be simplified by orienting the optical plate 15 perpendicular to the beam axis 13c in FIG. 24. Some of the output light 13 will then be reflected back toward the semiconductor laser 11, but the amount will be only about 0.2%, because most of the reflected light is focused toward the photodetector 14a by the reflection-type CGH 21. If necessary, an antireflection coating can be applied to the surface of the CGH 21 to reduce reflection into the semiconductor laser 11 to less than 0.2%, although the amount of monitor light 13a will then also be reduced.

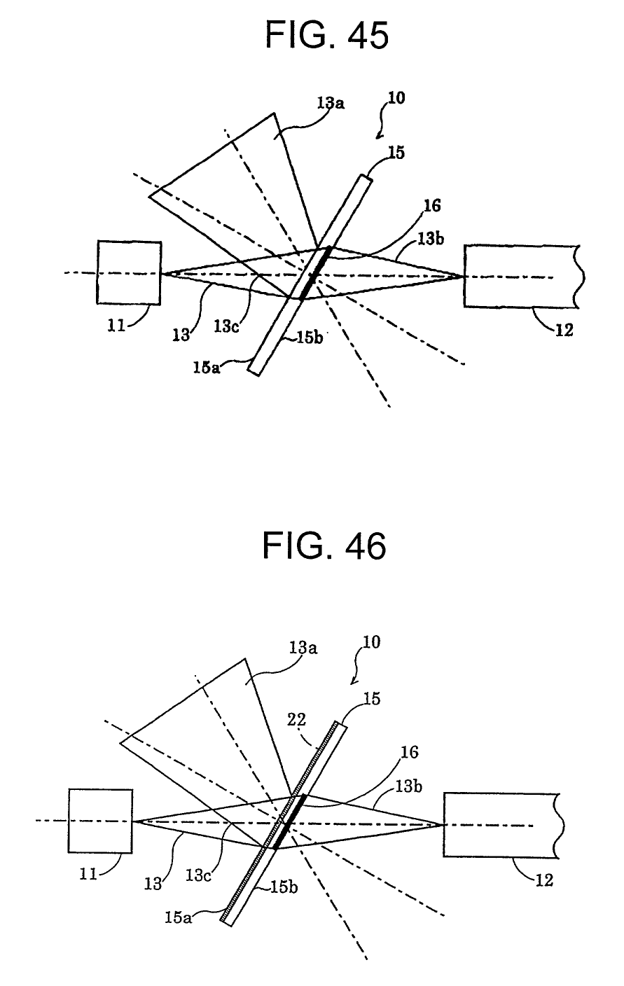

Referring to FIG. 45, a third optical device 10 embodying the present invention removes the reflection-type CGH 21 of the second embodiment and allows the front surface 15a of the optical plate 15 to reflect unfocused monitor light 13a toward the control unit 14 (not visible). A transmission-type CGH 16 is disposed on the back surface 15b, and operates as described in the preceding embodiments to focus transmitted light 13b toward the optical fiber 12.

The photodetector 14a (not visible) of the control unit 14 may be disposed at an arbitrary point in the beam of reflected monitor light 13a. It is not necessary for the photodetector 14a to detect all of the reflected light. An advantage of this arrangement is that the photodetector 14a does not have to be precisely positioned.

The amount of monitor light 13a reflected at the front surface 15a of the optical plate 15 and received by the photodetector 14a depends on the beam dispersion of the output light 13 emitted by the semiconductor laser 11, the index of refraction of the optical plate 15, and other factors. The arrangement in FIG. 45 is suitable when comparatively strong reflection is obtained at the front surface 15a.

If the reflection from the front surface 15a of the optical plate 15 is too strong, a multilayer dielectric film 22 may be deposited on the front surface 15a as in FIG. 46, to reduce the reflection to a desired level. The multilayer dielectric film 22 is a semitransparent coating that causes the front surface 15a to behave as a semitransparent mirror. The reflectivity of the front surface 15a of the optical plate 15 depends on the composition of the multilayer dielectric film 22, and can be controlled to obtain a desired intensity of monitor light 13a, or a desired balance between monitor light 13a and transmitted light 13b.

Since the desired reflectivity is typically neither extremely high nor extremely low, the intensity of the monitor light 13a, and of the transmitted light 13b, is not highly sensitive to minor variations in the fabrication of the optical plate 15 in FIG. 45 or the optical plate 15 and multilayer dielectric film 22 in FIG. 46. The ratio relationships among the output light 13, monitor light 13a, and transmitted light 13b are therefore substantially uniform under volume production conditions.

Depending on the reflectivity of the front surface 15a or multilayer dielectric film 22, less light may be transmitted through the optical plate 15 than in the preceding embodiments, but the transmitted light 13b is still focused efficiently into the optical fiber 12 by the CGH 16 on the back surface 15b, so adequate coupling of output light into the optical fiber 12 can be obtained.

The optical waveguide device into which the transmitted light 13b is focused may be, for example, a channel waveguide instead of the optical fiber 12 shown in the embodiments above. Any type of optical waveguide device may be employed in any embodiment.

As described above, the present invention uses a single optical plate 15, having a CGH formed on at least one surface, both to focus light emitted from a light source into an optical waveguide device (such as an optical fiber or a channel waveguide), and to extract part of the light as monitor light. Because of its unitary construction, the invented optical device requires no internal adjustments. The optical plate 15 requires neither a highly reflective coating nor an antireflection coating. The CGH can be fabricated with extreme precision by the well-developed techniques that are used to fabricate semiconductor integrated circuits. The amount of monitor light obtained is accordingly highly uniform, and the invented optical device is suitable for efficient high-volume production.

The invention is not limited to the embodiments described above. Those skilled in the art will recognize that further variations are possible within the scope claimed below.

What is claimed is:

1. An optical device receiving output light from an adjustable light source, coupling a first part of the output light into an optical waveguide device, and directing a second part of the output light to a control unit for feedback control of the adjustable light source, comprising:
an optical plate including a computer-generated hologram, the optical plate being disposed in a path of the output light and separating the output light into said first part and said second part, the computer-generated hologram focusing said first part of the output light into the optical waveguide device.

2. The optical device of claim 1, wherein the optical waveguide device is one of an optical fiber and a channel waveguide.

3. The optical device of claim 1, wherein the output light has a beam axis, and the optical plate is inclined at an oblique angle with respect to said beam axis.

4. The optical device of claim 1, wherein the optical plate has a first surface, said first part of the output light is transmitted through said first surface, and said second part of the output light is directed to the control unit by reflection at said first surface.

5. The optical device of claim 4, wherein the computer-generated hologram is disposed on said first surface, focuses said first part of the output light by diffraction of one order, and focuses said second part of the output light by diffraction of another order.

6. The optical device of claim 5, wherein said another order is higher than said one order.

7. The optical device of claim 4, wherein the optical plate has a second surface opposite said first surface, and the computer-generated hologram is disposed on said second surface.

8. The optical device of claim 7, wherein said optical plate also includes a reflection-type computer-generated hologram disposed on said first surface, the reflection-type computer-generated hologram focusing said second part of the output light.

9. The optical device of claim 7, wherein said optical plate has a semitransparent coating formed on said first surface, the semitransparent coating reflecting said second part of the output light while transmitting said first part of the output light.

10. The optical device of claim 1, wherein said computer-generated hologram is formed by etching of said optical plate, using computer-generated mask data.
